(19) United States
(12) Patent Application Publication
(10) Pub. No.: US 2025/0165864 A1
(43) Pub. Date: May 22, 2025

(54) Methods and Systems for Re-training a Machine Learning Model Using Predicted Features from Training Dataset

(71) Applicant: Mastercard International Incorporated, New York, NY (US)

(72) Inventors: Soumyadeep Ghosh, Gurgaon (IN); Harsimran Bhasin, New Delhi (IN); Maneet Singh, New Delhi (IN)

(21) Appl. No.: 18/948,401

(22) Filed: Nov. 14, 2024

(30) Foreign Application Priority Data
Nov. 20, 2023 (IN) 202341078833

(51) Int. Cl. G06N 20/00

(52) U.S. Cl. CPC G06N 20/00

(57) ABSTRACT

Methods and systems for re-training a Machine Learning (ML) model using predicted features from a training dataset are disclosed. A method performed by a server system includes accessing a training feature set and a testing feature set from a database. In response to identifying an inclusion of at least one new feature in the testing feature set, the method includes training a surrogate ML model to predict a value for the new feature based on the testing feature set and determining, by the surrogate ML model, a predicted value for the new feature for each training data sample in a training dataset based on the training feature set. The method further includes generating a new training feature set for each training data sample based on the predicted value and the training feature set. The method includes re-training the ML model based on the new training feature for each data sample.

### TECHNICAL FIELD

The present disclosure relates to a field of artificial intelligence-based processing systems and, more particularly, to electronic methods and complex processing systems for predicting or determining unknown features that appear during the testing or deployment phase of an Artificial Intelligence (AI) or Machine Learning (ML) model in a training dataset and re-training the AI/ML model using the predicted features from the training dataset of the AI/ML model.

### BACKGROUND

In recent times, Artificial Intelligence (AI) and/or Machine Learning (ML) based models have achieved remarkable success in performing predictions for a wide range of tasks including tasks on image, language, speech, graph data, and the like. AI/ML models trained using deep learning techniques have also gained popularity for performing various tasks in several industrial applications, such as web search, e-commerce, recommendation engines, server fault prediction, fraud detection in payments, and the like. As may be understood, such ML models must be trained using real-world data from a certain period before they can be deployed for performing any task. For instance, such models can be assessed in several real-time applications, including online or in-store payments, recommendation engines on e-commerce websites, cryptocurrency transfers, computing server fault prediction, etc., among other similar applications. Generally, the data that is used during the training phase and/or testing/evaluation phase of the model is derived from historical data collected over a predefined time interval in the past. Sometimes, historical data may be collected from different regions of the world as well. An essential condition for utilizing the trained model efficiently is to ensure that the set of features that were used to train the model must be available during the testing/evaluation phase for performing the requisite predictions. However, there might be situations where an additional set of features might appear during the evaluation or deployment phase. In other words, if the operator of the ML model starts collecting new information such as consumer email, consumer phone number, etc., along with other suitable information during the model deployment, this new information may open new avenues for improving the predictions made by the existing model. However, it would be apparent to those skilled in the art that features (i.e., new features) constructed from new information that was not present during the training phase in the training dataset cannot be used for model inferencing, since the model is not trained to identify new features. This in turn would adversely affect the performance of the existing model. In order to use this new information, the model operator would need to generate/train/learn a new ML model from a new training dataset that includes the new information. However, doing so would mean that no learning or inferencing can be done from the data present in the older training dataset, which would effectively mean a waste of valuable data resources.

In order to resolve the above-mentioned problem, an extensive amount of research has been conducted in several research fields associated with unknown categories in the input dataset. One such research field deals with data drift detection. Data drift detection studies whether the relationship between dependent and independent variables gets changed during production. Another field deals with open set learning, where the model analyzes test samples to recognize and classify not only the classes that were observed during training, but also identifies instances that do not belong to any known class (i.e., classes that have not been observed during training). Yet another field deals with incremental learning that involves processing incoming data by the model from a data stream continuously over time while updating its knowledge and adapting to the changes in the data from the input data stream.

In the case of open set learning, there are broadly two approaches to identify unknown categories in the training dataset. The first approach augments the training data to accommodate unknown categories, while the second approach applies post-training augmentation. The technical problem described herein is related to the first approach where unknown categories (i.e., features constructed from new information) are discovered in the training dataset itself.

Similarly, incremental learning can be divided into two areas. One area is a case where the current model is re-trained incrementally using newer data patterns to obtain a better model. In another area, the current model is re-trained by combining new and old data to form a better representative dataset. The domain of incremental learning can include three approaches. The first approach uses the discard-after-learn approach where new data is dropped after using it for model re-training. The second approach makes decisions to accept or reject new attributes, where a secondary neural network is trained on newer attributes which are eventually merged with the original neural network. The third approach identifies common attributes between different classes and aims to identify attributes of unseen object classes.

Conventionally, different approaches have been implemented to identify the unknown categories or features in the training dataset. These conventional approaches can be broadly classified into three approaches. The first approach identifies unknown classes and augments feature space to make such classes visible. In some implementations of this approach, feature information is explored in a training dataset for the discovery of unknown categories or features. Another implementation of the first approach augments the training dataset by adding generated examples close to the training dataset. Yet another implementation of the first approach utilizes unknown label detection to classify known features and unknown features. Other implementations of the first approach can use clustering-based regularization to discover unobserved labels within the training dataset. Further, some implementations of the first approach can use structure networks to differentiate class centers of known and unknown classes.

The second approach uses semi-supervised and unsupervised training to label unlabeled data which is clustered into seen and unseen classes. One of the implementations of this approach uses a two-stage framework for object detection and category discovery for labeling unseen classes. Another implementation of the second approach identifies new categories on-the-fly using hash coding. Yet another implementation of the second approach handles arbitrary unknown class distributions by utilizing class priorities. Further, another implementation of the second approach labels novel classes using online clustering. Yet another implementation of the second approach uses self-supervised and inductive methods for feature extrapolation.

The third approach uses outlier detection algorithms to identify new classes in the training dataset. One of the implementations of this approach uses an outlier calibration network and meta-training for identifying new classes. Another implementation of the third approach is location-agnostic outlier detection. Yet another implementation of the third approach uses class-conditioned adversarial samples for separating closed and open spaces. Another implementation of the third approach compares feature maps of train and testing datasets using local outlier factors to detect open set samples.

Although the conventional approaches described earlier attempt to identify new classes in the training dataset, they are unable to successfully identify new categorical features that may appear for some variables while the target classes remain the same. Since categorical features play a crucial role in the model inferencing process, this disadvantage needs to be addressed.

Further, in incremental learning, one approach tries to identify attributes of unseen classes. However, attribute identification has been carried out for computer vision applications, but how this approach can be used with tabular data has not been explored. More specifically, this approach tries to identify attributes for unseen classes and does not explore unseen categories in the training dataset, especially for tabular data.

Thus, a technological need exists for improved methods and systems for predicting or determining unknown features that appear during testing or deployment phase of an AI or ML model and re-training the AI/ML model using the predicted features from the training dataset of the AI/ML model.

### SUMMARY

Various embodiments of the present disclosure provide methods and systems for re-training a Machine Learning (ML) model using predicted features from a training dataset.

In an embodiment, a computer-implemented method for re-training a Machine Learning (ML) model using predicted features from a training dataset is disclosed. The computer-implemented method performed by a server system includes accessing a training feature set and a testing feature set from a database associated with the server system. Herein, the training feature set is associated with each training data sample in a training dataset and the testing feature set is associated with each testing data sample in a testing dataset. In response to identifying an inclusion of at least one new feature in the testing feature set, the method includes training a surrogate ML model to predict a value corresponding to the at least one new feature based, at least in part, on the testing feature set. Further, the method includes determining, by the surrogate ML model, a predicted value corresponding to the at least one new feature for each training data sample in the training dataset based, at least in part, on the training feature set. The method further includes generating a new training feature set for each training data sample based, at least in part, on the corresponding predicted value and the corresponding training feature set. Furthermore, the method includes re-training the ML model based, at least in part, on the new training feature set for each training data sample.

In another embodiment, a server system is disclosed. The server system includes a communication interface and a memory including executable instructions. The server system also includes a processor communicably coupled to the memory. The processor is configured to execute the instructions to cause the server system, at least in part, to access a training feature set and a testing feature set from a database associated with the server system. Herein, the training feature set is associated with each training data sample in a training dataset and the testing feature set is associated with each testing data sample in a testing dataset. In response to identifying an inclusion of at least one new feature in the testing feature set, the server system is caused to train a surrogate ML model to predict a value corresponding to the at least one new feature based, at least in part, on the testing feature set. Further, the server system is caused to determine, by the surrogate ML model, a predicted value corresponding to the at least one new feature for each training data sample in the training dataset based, at least in part, on the training feature set. The server system is further caused to generate a new training feature set for each training data sample based, at least in part, on the corresponding predicted value and the corresponding training feature set. Furthermore, the server system is caused to re-train the ML model based, at least in part, on the new training feature set for each training data sample.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a training feature set and a testing feature set from a database associated with the server system. Herein, the training feature set is associated with each training data sample in a training dataset and the testing feature set is associated with each testing data sample in a testing dataset. In response to identifying an inclusion of at least one new feature in the testing feature set, the method includes training a surrogate ML model to predict a value corresponding to the at least one new feature based, at least in part, on the testing feature set. Further, the method includes determining, by the surrogate ML model, a predicted value corresponding to the at least one new feature for each training data sample in the training dataset based, at least in part, on the training feature set. The method further includes generating a new training feature set for each training data sample based, at least in part, on the corresponding predicted value and the corresponding training feature set. Furthermore, the method includes re-training the ML model based, at least in part, on the new training feature set for each training data sample.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment related to at least some example embodiments of the present disclosure;

FIG. 2 illustrates a simplified block diagram of a server system, in accordance with an embodiment of the present disclosure;

FIG. 3A illustrates a schematic representation of an initial configuration of training and testing a Machine Learning (ML) model, in accordance with an embodiment of the present disclosure;

FIG. 3B illustrates a schematic representation of an approach of incorporating predicted features in a first training feature set for re-training the ML model, in accordance with an embodiment of the present disclosure;

FIG. 4 illustrates a graphical representation of experimental results obtained for a surrogate model for different input datasets, in accordance with an embodiment of the present disclosure;

FIG. 5 illustrates a graphical representation of experimental results for applying the proposed approach on a predefined dataset using classifier and regressor surrogate models, in accordance with an embodiment of the present disclosure;

FIG. 6 illustrates a graphical representation of experimental results for applying the proposed approach on another predefined dataset using a surrogate model, in accordance with an embodiment of the present disclosure;

FIG. 7 illustrates a graphical representation of experimental results for a relative change in a predefined performance metric after feature estimation for yet another defined dataset having features with different feature importance ranks, in accordance with an embodiment of the present disclosure;

FIG. 8 illustrates a graphical representation of experimental results for a relative change in a predefined performance metric after feature estimation for yet another defined dataset having features with different feature importance ranks, in accordance with an embodiment of the present disclosure;

FIG. 9 illustrates a graphical representation of experimental results for a relative change in feature importance rank after feature estimation for yet another defined dataset, in accordance with an embodiment of the present disclosure;

FIG. 10 illustrates a graphical representation of experimental results for mutual information rank of estimated variables with the target, in accordance with an embodiment of the present disclosure;

FIG. 11 illustrates a graphical representation of experimental results for comparison of gain observed on estimating feature v/s symmetrical uncertainty of feature with a target for a predefined dataset, in accordance with an embodiment of the present disclosure;

FIG. 12 illustrates a flow diagram depicting a method for identifying unknown features that appear during real-time model evaluation in a training dataset, in accordance with an embodiment of the present disclosure;

FIG. 13 illustrates a flow diagram depicting a method for re-training the ML model using the predicted features from the training dataset, in accordance with an embodiment of the present disclosure; and

FIG. 14 illustrates a simplified block diagram of a payment server, in accordance with an embodiment of the present disclosure.

The drawings referred to in this description are not to be understood as being drawn to scale except if specifically noted, and such drawings are only of example in nature.

### DETAILED DESCRIPTION

In the following description, for purposes of explanation, numerous specific details are set forth to provide a thorough understanding of the present disclosure. It will be apparent, however, to one skilled in the art that the present disclosure can be practiced without these specific details. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

For elucidatory purposes, the terms “payment transaction”, “financial transaction”, “e-commerce transactions”, “digital transaction”, and “transaction” are used interchangeably throughout the description and refer to a transaction of payment of a certain amount being initiated by the cardholder.

The terms “cardholder”, “user”, “account holder”, “consumer”, and “buyer” are used interchangeably throughout the description and refer to a person who has a payment account or at least one payment card (e.g., credit card, debit card, etc.) may or may not be associated with the payment account, that will be used by a merchant to complete the payment transaction that may be initiated by the cardholder. The payment account may be opened via an issuing bank or an issuer server.

The term “merchant”, used throughout the description generally refers to a seller, a retailer, a purchase location, an organization, or any other entity that is in the business of selling goods or providing services, and it can refer to either a single business location or a chain of business locations of the same entity.

The term “payment account” used throughout the description refers to a financial account that is used to fund a financial transaction. Examples of the financial account include but are not limited to a savings account, a credit account, a checking account, and a virtual payment account.

The term “issuer”, used throughout the description, refers to a financial institution normally called an “issuer bank” or “issuing bank” in which an individual or an institution may have an account. The issuer also issues a payment card, such as a credit card, a debit card, etc. Further, the issuer may also facilitate online banking services, such as electronic money transfer, bill payment, etc., to the cardholders through a server called “issuer server” throughout the description.

Further, the term “acquirer”, used throughout the description, refers to a financial institution (e.g., a bank) that processes financial transactions for merchants. In other words, this can be an institution that facilitates the processing of payment transactions for physical stores, merchants, or institutions that own platforms that make either online purchases or purchases made via software applications possible (e.g., the shopping cart platform providers and the in-app payment processing providers).

The terms “payment network” and “card network” are used interchangeably throughout the description and refer to a network or collection of systems used for the transfer of funds using cash substitutes. Payment networks may use a variety of different protocols and procedures to process the transfer of money for various types of transactions. Payment networks are companies that connect an issuing bank with an acquiring bank to facilitate online payment. It is to be noted that the payment networks are operated by organizations that are called “payment processors” throughout the description.

The term “payment card” and “card” are used interchangeably throughout the description and refer to a physical or virtual card that may or may not be linked with a financial or payment account. It may be presented to a merchant or any such facility to fund a financial transaction via the associated payment account. Examples of payment cards include, but are not limited to, debit cards, credit cards, prepaid cards, virtual payment numbers, virtual card numbers, forex cards, charge cards, e-wallet cards, and stored-value cards.

### OVERVIEW

Various embodiments of the present disclosure provide predicting or determining unknown features that appear during testing or deployment phase of an Artificial Intelligence (AI) or Machine Learning (ML) model (otherwise, also referred to as ML model, model, or AI model) and re-training the AI/ML model using the predicted features from the training dataset of the AI/ML model. As may be understood, conventionally, any AI/ML model is trained with a predefined dataset from a predefined time interval. This trained model is then used for performing several tasks at a later stage, which could even be several years after the training was completed. With time, new technologies are developed, as a result of which there is a possibility that new features appear, or the operator of the model has discovered new features. Conventionally, these new features are ignored, as a result of which the performance of the model gets negatively affected with time.

To address the above-mentioned problem, the present disclosure proposes methods and systems for incorporating values corresponding to such new features at the time of training the model. In a specific embodiment, the server system may be embodied within a payment server associated with a payment network. In an embodiment, the server system is configured to access an input dataset from a database of the server system. The input dataset may include a plurality of data samples associated with a plurality of users. In one embodiment, the input dataset can be split into the training dataset recorded for a training period (otherwise, also referred to as ‘predefined training period’) of the ML model and a testing dataset recorded for a testing period (otherwise, also referred to as ‘predefined testing period’) of the ML model. The server system can then generate a plurality of features for each data sample and store them in the database which can be accessed in the future. In one embodiment, the features can include a training feature set (otherwise, also referred to as ‘first training feature set’) generated for the training period and a testing feature set (otherwise, also referred to as ‘first testing feature set’) generated for the testing period of the ML model. It is to be noted that the training feature set can be associated with each training data sample and the testing feature set can be associated with each testing data sample in the testing dataset. The server system is further configured to access the features including the first training feature set for the predefined training period and the first testing feature set for the predefined testing period.

The server system is configured to train the ML model (otherwise also referred to as an ‘original ML model’) to perform a predefined task based on the training feature set and a corresponding ground truth label associated with each training data sample. In an embodiment, the predefined task may be any downstream task such as a classification task. For training the ML model, the server system may perform a first set of operations iteratively until first convergence criteria are met. The first set of operations may include: (i) initializing the ML model based, at least in part, on the training feature set and one or more first model parameters; (ii) generating, by the ML model, a predicted probability score for each training data sample in the training dataset based, at least in part, on the training feature set and the one or more first model parameters, the predicted probability score indicating a likelihood of performing the predefined task; (iii) generating, by the ML model, a prediction for the predefined task based, at least in part, on the predicted probability score and a task threshold, the prediction including a label associated with the predefined task; (iv) computing, by the ML model, a loss for each training data sample in the training dataset based, at least in part, on the prediction, the corresponding ground truth label, and a loss function; and (v) optimizing the one or more first model parameters based, at least in part, on the loss.

Later, the server system may determine a set of new features that have appeared during the predefined testing period by comparing the first testing feature set with the first training feature set. In one embodiment, the set of new features can include at least one new feature. Further, in response to determining an inclusion of the at least one new feature in the first testing feature set, the server system may train a surrogate model (otherwise, also referred to as ‘surrogate ML model’) to predict a value corresponding to the at least new feature that have appeared during the predefined testing period based, at least in part, on the first testing feature set. Herein, the term ‘a value’ can refer to a set of values, and the terms ‘value’ and ‘set of values’ can be used interchangeably throughout the description.

In some embodiments, before training the surrogate ML model, the server system identifies a relationship between the at least one new feature and the testing feature set based, at least in part, on the testing feature set. In response to identifying that the relationship corresponds to a linear relationship, the server system may discard the at least one new feature for training the surrogate ML model. Alternatively, in response to identifying that the relationship corresponds to a non-linear relationship, the server system may train the surrogate ML model to predict the value corresponding to the at least one new feature.

In one embodiment, for training the surrogate ML model, the server system performs a second set of operations iteratively until second convergence criteria are met. The second set of operations can include: (i) initializing the surrogate ML model based, at least in part, on the testing feature set and one or more second model parameters; (ii) generating, by the surrogate ML model, a predicted probability score for each testing data sample in the testing dataset based, at least in part, on the testing feature set and the one or more second model parameters, the predicted probability score indicating a likelihood of predicting the value for the at least one new feature; (iii) generating, by the surrogate ML model, a prediction for the value corresponding to the at least one new feature based, at least in part, on the predicted probability score and a threshold, the prediction including the value for the at least one new feature; (iv) computing, by the surrogate ML model, a loss for each testing data sample in the testing dataset based, at least in part, on the prediction, the identified at least one new feature, and a loss function; and (v) optimizing the one or more second model parameters based, at least in part, on the loss.

Further, using the surrogate model, the server system may then predict a set of new feature values that have appeared during the predefined testing period based, at least in part, on the first testing feature set. In other words, using the surrogate ML model, the server system can determine a predicted value corresponding to the at least one new feature for each training data sample in the training dataset based, at least in part, on the training feature set. Then, the server system may generate a new training feature set (otherwise, also referred to a ‘second training feature set’) for each training data sample based, at least in part, on the corresponding predicted value and the corresponding training feature set. More specifically, in one embodiment, the server system concatenates these values with the first training feature set to obtain the second training feature set. Further, the server system may re-train the original ML model to perform the predefined task based, at least in part, on the second training feature set.

In one embodiment, for re-training the ML model to obtain a re-trained model, the server system performs a third set of operations iteratively until third convergence criteria are met. The third set of operations can include: (i) initializing the ML model based, at least in part, on the new training feature set, a corresponding ground truth label associated with each training data sample, and the one or more first model parameters; (ii) generating, by the ML model, a new predicted probability score for each training data sample in the training dataset based, at least in part, on the new training feature set and the one or more first model parameters, the new predicted probability score indicating a likelihood of performing the predefined task; (iii) generating, by the ML model, a new prediction for the predefined task based, at least in part, on the new predicted probability score and the task threshold, the new prediction including a new label associated with the predefined task; (iv) computing, by the ML model, a loss for each training data sample in the training dataset based, at least in part, on the new prediction, the corresponding ground truth label, and a loss function; and (v) optimizing the one or more first model parameters based, at least in part, on the loss. This re-trained ML model, when used to perform the predefined task, provides results such that the performance of the re-trained model is measurably better than the original ML model.

In a non-limiting implementation, the server system may receive a prediction request related to a predefined task from a user. Further, the server system may generate a new prediction corresponding to the predefined task based, at least in part, on the testing feature set for each testing data sample, the testing feature set including the at least one new feature. In one embodiment, the server system may generate the new prediction using the re-trained ML model. Furthermore, in response to the prediction request, the server system may transmit the new prediction to the user.

In another non-limiting implementation, the server system may compute a first performance metric associated with the ML model based, at least in part, on the testing feature set. The server system may further compute a second performance metric associated with a re-trained ML model based, at least in part, on the testing feature set. Then, the server system may compute an improvisation factor based, at least in part, on the first performance metric and the second performance metric. The improvisation factor may indicate an extent of a positive impact on the performance of the ML model due to the re-training process.

Various embodiments of the present disclosure offer multiple advantages and technical effects. For instance, the methods and the systems proposed in the present disclosure facilitate the utilization of features not available during training for testing without negatively affecting the performance of the model. Instead, the performance is enhanced. It is to be noted that the proposed approach can be applied to categorical features as well. In an example scenario, the features utilized during the training process had two categories of features, i.e., category A and category B, and during the testing phase, two new categories of features, i.e., category C and category D are introduced. Then, in such a scenario, the proposed approach can re-train the ML model to estimate or predict category C and category D as well. The approach described herein is a model-agnostic approach that benefits from the additional features that are available during testing/evaluation and not during training. In other words, the approach of the present disclosure can be applied to any existing AI or ML model to improve their performance. It is to be noted that the proposed approach applies to a wide variety of real-world datasets that also include tabular datasets, unlike conventional approaches.

For instance, when an ML model is used for diagnosing a disease in a patient ‘A’, the ML model can be trained using a training feature set recorded for different patients and for a training period of one year. The training feature set can include features such as gender, family medical history, smoking status, geographic region, etc. After several months when this ML model is tested for its operation, new features may have appeared such as the occupation type of the patients. However, since this feature was not considered during the training period, the ML model, during the testing period will fail to consider this new feature while preforming predictions for the disease diagnosis for the patient ‘A’. The proposed approach identifies a scope of improvement in the performance of the ML model by predicting and incorporating values for the new feature that was introduced during the testing period in the training feature set of the ML model. Once this new feature is determined for the training feature set, then the ML model can be re-trained. Thus, upon re-training, when the re-trained model is used for diagnosing the disease in the patient ‘A’, the predictions thus generated are observed to have better accuracy and precision. Also, the performance of the re-trained model is observed to be better than the original ML model.

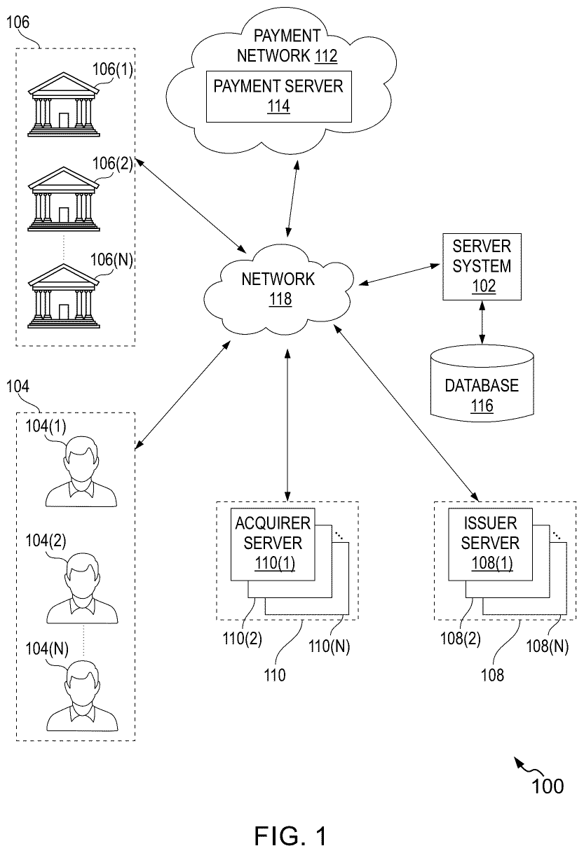

Various example embodiments of the present disclosure are described hereinafter with reference to FIGS. 1 to 14.

FIG. 1 illustrates an example representation of an environment 100 related to at least some example embodiments of the present disclosure. Although the environment 100 is presented in one arrangement, other embodiments may include the parts of the environment 100 (or other parts) arranged otherwise depending on, for example, predicting or determining a set of values corresponding to unknown features that appear during the testing or deployment phase of an Artificial Intelligence (AI) or Machine Learning (ML) model, so that the AI or ML model could be re-trained by considering these newly determined/predicted features. It is to be noted that the term ‘AI model’ or ‘ML model’ throughout the description, is otherwise, also referred to as an ‘ML model’, a ‘model’, or an ‘AI model’ interchangeably.

In order to illustrate the approach proposed in the present disclosure, an example of a real-world application such as payment fraud detection is considered in the present disclosure. However, it would be apparent to those skilled in the art, that the scope of the proposed approach is not limited to the same and the various embodiments described herein may be used for any open set learning/inferential learning-related problem in a variety of industries such as healthcare, financial technology, hospitality, and the like. In payment fraud detection-related problems, the training dataset used to train the model is generally historical transaction-related data that is tabular in nature. The model may be a classifier model that is trained on fraudulent (or ‘fraud’) and non-fraudulent (or ‘non-fraud’) transaction data for a specific time interval (otherwise, also referred to as ‘predefined training period’). The model is expected to score real-time transactions on the likelihood of them being fraud or non-fraud transactions.

The environment 100 for such an example, generally includes a plurality of entities, such as a server system 102, a plurality of cardholders 104(1), 104(2), . . . 104(N) (collectively referred to hereinafter as a ‘plurality of cardholders 104’ or simply ‘cardholders 104’), a plurality of merchants 106(1), 106(2), . . . 106(N) (collectively referred to hereinafter as a ‘plurality of merchants 106’ or simply ‘merchants 106’), a plurality of issuer servers 108(1), 108(2), . . . 108(N) (collectively referred to hereinafter as a ‘plurality of issuer servers 108’ or simply ‘issuer servers 108’), a plurality of acquirer servers 110(1), 110(2), . . . 110(N) (collectively referred to hereinafter as a ‘plurality of acquirer servers 110’ or simply ‘acquirer servers 110’), a payment network 112 including a payment server 114, and a database 116 each coupled to, and in communication with (and/or with access to) a network 118. Herein, ‘N’ is a non-zero natural number, and the value of ‘N’ may or may not be the same for the plurality of entities shown in FIG. 1. The network 118 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 118 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, New Radio (NR) communication protocol, any future communication protocol, or any combination thereof. In some instances, the network 118 may utilize a secure protocol (e.g., Hypertext Transfer Protocol (HTTP), Secure Socket Lock (SSL), and/or any other protocol, or set of protocols for communicating with the various entities depicted in FIG. 1.

In one embodiment, the server system 102 is configured to facilitate payment processors that control the payment network 112 to perform several operations required for re-training the ML model using predicted features from a training dataset. The details of these operations and various other configurations of the server system 102 are explained later in the present disclosure.

In an embodiment, a cardholder (e.g., the cardholder 104(1)) may be any individual, representative of a corporate entity, a non-profit organization, or any other person who is presenting payment account details during an electronic payment transaction. The cardholder (e.g., the cardholder 104(1)) may have a payment account issued by an issuing bank (not shown in figures) associated with an issuer server (e.g., the issuer server 108(1)). In a non-limiting implementation, the cardholder 104(1) can be provided with a payment card. The payment card may have financial, or other account information encoded such that the cardholder 104(1) uses the payment card to initiate and complete a payment transaction using a bank account at the issuing bank.

In another embodiment, the cardholders 104 may use their corresponding electronic devices (not shown in figures) to access a mobile application or a website associated with the issuing bank, or any third-party payment application to perform a payment transaction. In various non-limiting examples, the electronic devices may refer to any electronic devices, such as but not limited to, Personal Computers (PCs), tablet devices, smart wearable devices, Personal Digital Assistants (PDAs), voice-activated assistants, Virtual Reality (VR) devices, smartphones, laptops, and the like.

In one embodiment, the cardholders 104 may be associated with financial institutions such as issuing banks who are associated with the issuer servers 108. The terms “issuer bank”, “issuing bank” or simply “issuer”, and “issuer servers”, hereinafter may be used interchangeably. It may be understood that a cardholder (e.g., the cardholder 104(1)) may have the payment account with the issuing bank (that may issue a payment card, such as a credit card or a debit card to the cardholders 104). Further, the issuing banks provide microfinance banking services (e.g., payment transactions using credit/debit cards) for processing electronic payment transactions, to the cardholder (e.g., the cardholder 104(1)).

In an embodiment, the merchants 106 may include retail shops, restaurants, supermarkets or establishments, government and/or private agencies, or any such places equipped with POS terminals, where the cardholders 104 visit to perform financial transactions in exchange for any goods and/or services or any financial transactions. In an embodiment, the merchants 106 are generally associated with financial institutions such as acquiring banks who are associated with the acquirer servers 110. The terms “acquirer”, “acquiring bank”, “acquirer server”, and “acquirer servers” will be used interchangeably hereinafter. The acquiring bank can be an institution that facilitates the processing of payment transactions for physical stores, merchants, or institutions that own platforms that make either online purchases or purchases made via software applications possible.

In one scenario, the cardholders 104 may use their corresponding payment accounts to conduct payment transactions with the merchants 106. Moreover, it is to be noted that each of the cardholders 104 may use their corresponding payment cards differently or make the payment transaction using different modes of payment, such as net banking, Unified Payments Interface (UPI) payment, card transaction, cheque transaction, etc. For instance, the cardholder 104(1) may enter payment account details on an electronic device (not shown) associated with the cardholder 104(1) to perform an online payment transaction. In another instance, the cardholder 104(2) may utilize a payment card to perform an offline payment transaction. In yet another instance, another cardholder may enter details of the payment card to transfer funds in the form of fiat currency on an e-commerce platform to buy goods.

Due to the complexity of the banking network, in some embodiments, the cardholder 104(1) and the merchant 106(1) can be associated with the same banking institution, e.g., ABC Bank. In such a situation, the ABC Bank will act as an issuer for the cardholder 104(1) and an acquirer for the merchant 106(1). Thus, a banking institution may act as both an acquirer and/or an issuer depending on the needs of its clients.

In one embodiment, the payment network 112 may be used by the payment card issuing authorities such as the issuers, as a payment interchange network. A payment interchange network allows exchanging electronic payment transaction data between the issuers and the acquirers. The payment network 112 includes the payment server 114 which is responsible for facilitating the various operations of the payment network 112. In one scenario, the payment server 114 is configured to operate a payment gateway for facilitating the various entities in the payment network 112 to perform digital transactions.

As mentioned earlier, any AI/ML model, such as any classification or regression model needs access to the same features or input that were utilized to train the model for determining their desired output (e.g., a class prediction for a data sample). However, in real-world scenarios, several models may have been in operation or deployment for years, and in those cases, new variables/features may be available during the inferencing stage. If such features are to be utilized, their values have to be captured in a dataset that is utilized for training the model. For example, when a model is trained for payment fraud detection using data from January 2015-January 2017, the organization or the operator that built this model may start collecting some extra attributes (e.g., card type, Merchant Category Code (MCC), etc.) for transactions during the evaluation or deployment phase i.e., from January 2022-January 2023. Since these attributes were not collected/observed during the training period (January 2015-January 2017), the model cannot be re-trained with those additional attributes because they do not exist for that period.

Moreover, conventional approaches such as the ones that are based on open set learning or incrementation learning as described earlier, have not explored the problem where new categorical features appear for some variables while the target classes remain the same. Also, identifying attributes of unseen classes has not been explored on tabular data.

Therefore, there is a need for a technical solution for predicting or determining unknown features that appear during testing or deployment phase of an AI or ML model, so that the model can be re-trained by considering these newly determined/predicted features in the training dataset.

The above-mentioned technical problems, among other problems, are addressed by one or more embodiments implemented by the server system 102 and the methods thereof provided in the present disclosure. The method proposed in the present disclosure facilitates the incorporation of the one or more extra attributes (newly identified or introduced features) in a trained model by re-training the model. In particular, the present disclosure is intended to develop an approach for predicting or identifying features that may appear while testing the model in real-time. Upon predicting these unknown features, the model can be re-trained for these new features and a better model performance can be obtained. The server system 102 proposed in the present disclosure facilitates the implementation of such an approach.

In one embodiment, the server system 102 is used by a managing entity (not shown) to train the ML model and use it for generating predictions related to a downstream task. In a non-limiting implementation, the managing entity may be any individual, representative of a person, an institution, an organization, a corporate entity, a non-profit organization, a financial institution, a bank, medical facilities (e.g., hospitals, laboratories, etc.), educational institutions, government agencies, telecom industries, weather forecast agency, or the like. In an example, the managing entity may be an administrator of the server system 102. Examples of the downstream task include but are not limited to, weather forecasting, speech recognition, image classification, email spam detection, performing medical diagnosis, fraud detection, risk management, charge-back decision-making systems, payment authorization systems, data analytics, credit card scoring systems, cross-border transaction management systems, consumer segmenting, or the like.

In an embodiment, the server system 102 may store an input dataset in the database 116, based on which the model is trained to perform any downstream task such as a classification task. In various non-limiting examples, the database 116 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a Redundant Array of Independent Disks (RAID) controller, a Storage Area Network (SAN) adapter, a network adapter, and/or any component providing the server system 102 with access to the database 116. In one implementation, the database 116 may be viewed, accessed, amended, updated, and/or deleted by an operator, an administrator, or a managing entity associated with the server system 102 through a database management system (DBMS) or relational database management system (RDBMS) present within the database 116.

In a specific example, the server system 102 coupled with the database 116 is embodied within the payment server 114 associated with the payment processor. However, in other examples, the server system 102 can be a standalone component (acting as a hub) connected to the issuer servers 108 and the acquirer servers 110. The database 116 may be incorporated in the server system 102 or maybe an individual entity connected to the server system 102 or maybe a database stored in cloud storage. In the payment industry, the managing entity may correspond to the payment processor.

In one embodiment, the input dataset can include a plurality of data samples associated with a plurality of users. In a non-limiting example, the users correspond to individuals whose data is used for training the models. For instance, in the payment industry (as shown in FIG. 1), the users may be the cardholders 104, the merchants 106, the issuers 108, the acquirers 110, third-party users, financial institutions, and the like. Data related to such individuals contributing to the input dataset may include historical information corresponding to a plurality of payment transactions performed between the cardholders 104 and the merchants 106. In an embodiment, the historical information may include, but is not limited to, transaction attributes, such as transaction amount, source of funds, such as bank accounts, debit cards or credit cards, transaction channel used for loading funds, such as POS terminal or Automated Teller Machine (ATM), transaction velocity features, such as count and transaction amount sent in the past ‘x’ number of days to a particular user, transaction location information, external data sources, merchant country, merchant Identifier (ID), cardholder ID, cardholder product, cardholder Permanent Account Number (PAN), Merchant Category Code (MCC), merchant location data or merchant co-ordinates, merchant industry, merchant super industry, ticket price, etc., among other transaction-related attributes. Such data can be used to train AI or ML models to perform various downstream tasks such as predicting the income of an individual, predicting financial frauds and risks, performing payment authorization operations, and the like.

In an example related to the medical industry, the term ‘users’ can refer to patients who are undergoing treatment for certain diseases. Data corresponding to such patients contributing to the input dataset can be medical history, symptoms, diagnostic tests, treatments, outcomes, and the like. This data can be used to learn and understand the experience of the patients at a particular clinical center by training AI or ML models to identify diseases and diagnoses. In various examples, the downstream task for the ML model may include classifying different diseases, such as cancer using images, predicting the progression of pre-diabetes, predicting response to depression treatment, etc., among other suitable tasks.

Initially, for training the ML model, the input dataset may be split into a training dataset, a validation dataset, and a testing dataset (otherwise also referred to as an ‘evaluation dataset’) based on a predefined time interval. For instance, if the input dataset that is used for building the model is captured across 12 months of the year 2022, then the first 4 months of data (i.e., January-April, 2022) can be considered a training period (otherwise, also referred to as a ‘predefined training period’) for the training dataset. Then, the next 4 months data (i.e., May-August, 2022) can be considered for the validation period (otherwise, also referred to as a ‘predefined validation period’) for the validation dataset. Similarly, the last 4 months data (i.e., September-December, 2022) can be considered as the testing period (otherwise, also referred to as a ‘predefined testing period’) for the testing dataset. The predefined time interval for segregating the input dataset into the training dataset, the validation dataset, and the testing dataset may be defined by the administrator based on the internal policies of the organization associated with the administrator. In other words, the training period, the validation period, and the testing period are decided by the administrator.

Further, in one embodiment, the server system 102 is configured to generate a plurality of features for each data sample of the plurality of data samples based, at least in part, on the input dataset. More specifically, the server system 102 may generate the features from the input dataset based, at least in part, on one or more feature extraction or generation techniques. In various non-limiting examples, the feature extraction or generation techniques may include one-hot encoding, domain-specific feature engineering, target encoding, binning, logarithmic transformation, and the like. In another embodiment, the server system 102 further stores the features in the database 116. In a non-limiting implementation, the server system 102 can also store several AI/ML models or algorithms that may be trained to perform several tasks in the database 116.

In a specific embodiment, the server system 102 may generate a training feature set, a validation feature set, and a testing feature set based, at least in part, on the input dataset for their respective training dataset, validation dataset, and testing dataset. In other words, the plurality of features may include the training feature set generated for the training period, the validation feature set generated for the validation period, and the testing feature set generated for the testing period.

Further, while testing the model, new features might appear during the time interval of September-December, 2022. For instance, if the operator training the model starts engaging in Three Domain Secure 2.0 (or 3DS 2) transactions, the new transaction data collected between September-December, 2022 will include additional 3DS-2 data that can be used to construct or engineer 3DS-2-related features. Since these features were not available at the time of training the model i.e., during the first 4 months of the year 2022, the testing results of the model may not be accurate due to the introduction of the new features which are ignored by the model, thereby negatively affecting the performance of the model.

For the server system 102 to be able to consider these newly introduced features at the time of training the model, the server system 102 may train a new model (hereinafter, also referred to as a ‘surrogate model’, a ‘surrogate ML model’, or a ‘second ML model’) to predict one or more unknown features such as a set of new features based, at least in part, on the testing feature set. In one embodiment, the set of new features can include at least one new feature. More specifically, in response to determining an inclusion of the at least one new feature in the testing feature set, the server system 102 may train the surrogate ML model to predict a value corresponding to the at least one new feature based, at least in part, on the testing feature set. Herein, the term ‘a value’ can refer to a set of values, and the terms ‘value’ and ‘set of values’ can be used interchangeably throughout the description. This newly trained model can then be used to predict values for the one or more unknown features for each training data sample in the training dataset for a training time interval such as the training period. In other words, the server system 102 may use the surrogate ML model to generate the predicted value corresponding to the at least one new feature based, at least in part, on the training feature set. Upon predicting the values for the one or more unknown features for the training time interval, these predicted values may be combined with the training feature set and a new training feature set (otherwise, also referred to as a ‘second training feature set’) may be generated. This new training feature set may then be used for training a new model or re-training the previous model (i.e., the original ML model) for performing the downstream task such as any classification task. Further, the same model may then be tested for its operation using the testing feature set including the new features that appear during the testing phase of the model. This way the new features that may appear during the testing period get considered during the training period itself, thereby maintaining the performance of the model as it is or improving the performance of the model when compared with its previous version.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 118, which may be specifically configured, via executable instructions, to perform steps as described herein, and/or embodied in at least one non-transitory computer-readable media.

More specifically, it should be noted that the number of cardholders, merchants, issuer servers, acquirer servers, payment network, and database described herein are only used for exemplary purposes and do not limit the scope of the invention. The main objective of the invention is to facilitate the inclusion of the features that may appear while testing or deployment of a model, during the training period of the model itself, so that the performance of the model can be improved.

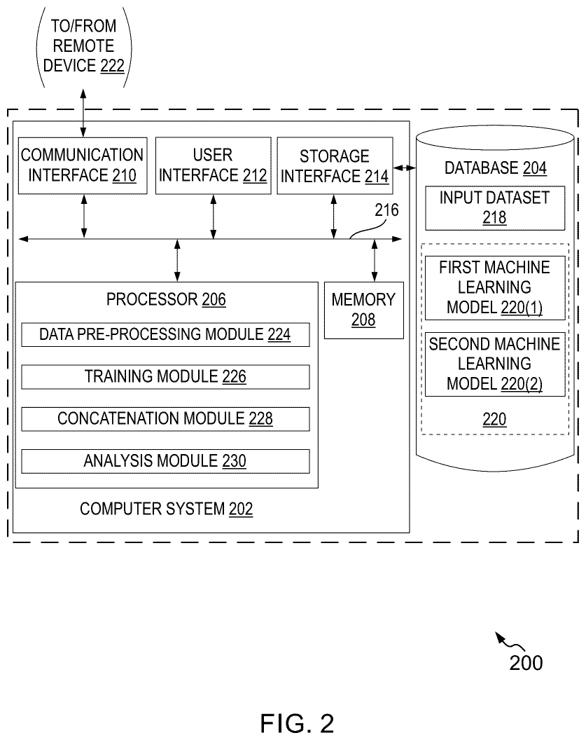

FIG. 2 illustrates a simplified block diagram of a server system 200, in accordance with an embodiment of the present disclosure. For example, the server system 200 is similar to the server system 102 as described in FIG. 1. In some embodiments, the server system 200 is embodied as a standalone physical server and/or has a cloud-based and/or SaaS-based (software as a service) architecture.

The server system 200 includes a computer system 202 and a database 204. The computer system 202 includes at least one processor such as a processor 206 for executing instructions, a memory 208, a communication interface 210, a user interface 212, and a storage interface 214. The one or more components of the computer system 202 communicate with each other via a bus 216. The components of the server system 200 provided herein may not be exhaustive and the server system 200 may include more or fewer components than those depicted in FIG. 2. Further, two or more components depicted in FIG. 2 may be embodied in one single component, and/or one component may be configured using multiple sub-components to achieve the desired functionalities. The database 204 is an example of the database 116 of FIG. 1.

In some embodiments, the database 204 is integrated into the computer system 202. For example, the computer system 202 may include one or more hard disk drives as the database 204. In one non-limiting example, the database 204 is configured to store an input dataset 218 and one or more Machine Learning (ML) models 220 such as a first ML model 220(1) and a second ML model 220(2). It is to be noted that the input dataset 218, the first ML model 220(1), and the second ML model 220(2) are similar to the input dataset, the original ML model, and the surrogate ML model as described in the description of FIG. 1.

Further, the computer system 202 may include one or more hard disk drives as the database 204. The user interface 212 is an interface such as a Human Machine Interface (HMI) or a software application that allows users such as an administrator to interact with and control the server system 200 or one or more parameters associated with the server system 200. It is to be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 with access to the database 204. The storage interface 214 may include, for example, an ATA adapter, a SATA adapter, a SCSI adapter, a RAID controller, a SAN adapter, a network adapter, and/or any component providing the processor 206 with access to the database 204.

It is to be noted that although the computer system 202 is depicted to include only one processor, the computer system 202 may include a greater number of processors therein. The processor 206 includes a suitable logic, circuitry, and/or interfaces to execute computer-readable instructions for performing one or more operations for predicting or determining unknown features that appear during the testing or deployment phase of an AI or ML model such as the first ML model 220(1), so that the model could be re-trained by considering these newly determined/predicted features. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like.

In one embodiment, the memory 208 is capable of storing the computer-readable instructions. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the computer system 202 is capable of communicating with a remote device 222, such as the issuer servers 108, the acquirer servers 110, or with any entity connected to the network 118 (as shown in FIG. 1).

It is to be noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

The processor 206 is depicted to include a data pre-processing module 224, a training module 226, a concatenation module 228, and an analysis module 230. It should be noted that components described herein can be configured in a variety of ways, including electronic circuitries, digital arithmetic, logic blocks, and memory systems in combination with software, firmware, and embedded technologies. Moreover, it may be noted that the data pre-processing module 224, the training module 226, the concatenation module 228, and the analysis module 230 may be communicably coupled with each other to exchange information with each other for performing the one or more operations facilitated by the server system 200.

In one embodiment, the data pre-processing module 224 may include suitable logic and/or interfaces for accessing the input dataset 218 from the database 204. In an embodiment, the input dataset 218 may be split into the training dataset, the testing dataset, and the validation dataset, as mentioned earlier. Further, the data pre-processing module 224 may be configured to generate the plurality of features from the input dataset 218 based, at least in part, on the feature extraction technique. The data pre-processing module 224 may further store the features in the database 204.

In an embodiment, the input dataset 218 corresponds to information related to historical payment transactions. In a non-limiting example, the input dataset 218 may include the plurality of data samples in a tabular format thus, making the input dataset 218 tabular in nature. Further, as the input dataset 218 is tabular in nature, the feature extraction techniques that may be employed for extracting or generating features from the input dataset 218 may involve transforming raw data i.e., the input dataset 218 in structural tables into a format that is suitable for training several AI/ML models. In some non-limiting examples, the feature extraction techniques may include statistical techniques, scaling and normalization techniques, binning/discretization techniques, encoding categorical variables techniques, aggregation techniques, feature scaling techniques, one hot encoding, etc. In a specific embodiment, the features include a first training feature set (or the training feature set) for a predefined training period (or the training period) and a first testing feature set (or the testing feature set) for a predefined testing period (or the testing period). The first training feature set and the first testing feature set may be provided to the training module 226.

In one embodiment, the training module 226 may include suitable logic and/or interfaces for accessing the plurality of features from the database 204 associated with the server system 200. The training module 226 may further be configured to train the first ML model 220(1) to perform a predefined task based, at least in part, on the first training feature set. Examples of the first ML model 220(1) can be a random forest model, a gradient boost model, a logistic regression-based model, a Support Vector Machine (SVM)-based model, a Neural Network (NN)-based model, etc. In an embodiment, the predefined task may be a classification task to classify payment transactions into one of two classes, i.e., a fraud transaction class and a non-fraud transaction class. It is to be noted that each training data sample in the first training feature set can be associated with a corresponding ground truth label.

In another embodiment, for training the first ML model 220(1), the training module 226 is configured to perform a first set of operations iteratively until first convergence criteria are met. The first set of operations may include: (i) initializing the first ML model 220(1) based, at least in part, on the training feature set and one or more first model parameters; (ii) generating, by the first ML model 220(1), a predicted probability score for each training data sample in the training dataset based, at least in part, on the training feature set and the one or more first model parameters, the predicted probability score indicating a likelihood of performing the predefined task; (iii) generating, by the first ML model 220(1), a prediction for the predefined task based, at least in part, on the predicted probability score and a task threshold, the prediction including a label associated with the predefined task; (iv) computing, by the first ML model 220(1), a loss for each training data sample in the training dataset based, at least in part, on the prediction, the corresponding ground truth label, and a loss function; and (v) optimizing the one or more first model parameters based, at least in part, on the loss. In a non-limiting example, the optimization step can be performed based, at least on a backpropagating the loss.

In a non-limiting implementation, the first convergence criteria can include saturation of the loss. In an embodiment, the loss may saturate after a plurality of iterations of the first set of operations is performed. Herein, saturation may refer to a stage in the model training process after a certain number of iterations where a loss value (e.g., the loss) becomes constant, i.e., the difference in the loss for one iteration and its subsequent iteration becomes the same or negligible. The loss of any model is associated with model performance, and hence it may be understood that if the loss reduces, there is an improvement in the model performance. Once the first convergence criteria are met, the first ML model 220(1) can generate the predicted probability score that is highly accurate, thereby generating a highly accurate prediction for the predefined task.

In a non-limiting example, the one or more first model parameters may be initialized based at least on the type of the model chosen for the first ML model 220(1). In various examples, the one or more first model parameters can include, but not be limited to, coefficients or weights associated with each feature, bias terms, regularization parameters, and the like. In various other examples, the one or more first model parameters can include hyperparameters, such as leaning rate, epochs, kernel depth for SVM-based models, depth of trees for decision tree-based models, a number of layers, and a number of neurons in a hidden layer of NN-based models, batch size, and the like depending on the type of model being trained or re-trained.

At the time of testing or deployment of the first ML model 220(1), new features may appear in the testing dataset. Thus, in an embodiment, the analysis module 230 may include suitable logic and/or interfaces for determining a set of new features that have appeared during the predefined testing period based, at least in part, on comparing the first testing feature set with the first training feature set. The set of new features includes the at least one new feature that can appear during the predefined testing period.

Further, for the server system 200 to be able to consider these new features at the time of the training phase, a new ML model may have to be trained to predict such features. Thus, in one embodiment, the training module 226 may further be configured to train the second ML model 220(2) (a surrogate model or a surrogate ML model) to predict a set of new features that have appeared during the predefined testing period based, at least in part, on the first testing feature set. In other words, in response to determining the inclusion of the at least one new feature in the first testing feature set, the training module 226 may be configured to train the second ML model 220(2) to predict a value corresponding to the at least one new feature based, at least in part, on the first testing feature set. Examples of the second ML model 220(2) can be a random forest model, a gradient boost model, a logistic regression-based model, a Support Vector Machine (SVM)-based model, a Neural Network (NN)-based model, etc., among other suitable models.

In one embodiment, before training the second ML model 220(2), the analysis module 230 identifies a relationship between the at least one new feature and the testing feature set based, at least in part, on the testing feature set. In response to identifying that the relationship corresponds to a linear relationship, the analysis module 230 may discard the at least one new feature for training the second ML model 220(2). Thus, it may be understood that if there exists a linear relationship between the new feature and any of the features in the testing feature set, then said features may cover the essence of these newly determined features as well. To that end, considering said features for training the second ML model 220(2) does not add to the performance of the first ML model 220(1). Thus, the new features that are linearly related to any of the features in the testing feature set are discarded and not considered for training the second ML model 220(2). Further, in response to identifying that the relationship corresponds to a non-linear relationship, the analysis module 230 may train the second ML model 220(2) to predict the value corresponding to the at least one new feature. It is noted that the non-linear relationship indicates a possibility of improvement in the performance of the first ML model 220(1) upon re-training the model using the predicted value corresponding to the new feature in the training dataset.

Furthermore, for training the second ML model 220(2) to predict the value for the at least one new feature, the training module 226 may be configured to perform a second set of operations iteratively until second convergence criteria are met. The second set of operations may include: (i) initializing the second ML model 220(2) based, at least in part, on the first testing feature set and one or more second model parameters; (ii) generating, by the second ML model 220(2), a predicted probability score for each testing data sample in the first testing dataset based, at least in part, on the first testing feature set and the one or more second model parameters, the predicted probability score indicating a likelihood of predicting the value for the at least one new feature; (iii) generating, by the second ML model 220(2), a prediction for the value corresponding to the at least one new feature based, at least in part, on the predicted probability score and a threshold, the prediction including the value for the at least one new feature; (iv) computing, by the second ML model 220(2), a loss for each testing data sample in the testing dataset based, at least in part, on the prediction, the identified at least one new feature, and a loss function; and (v) optimizing the one or more second model parameters based, at least in part, on the loss. In a non-limiting example, the optimization step can be performed based, at least on a backpropagation of the loss. Also, it is to be noted that the identified at least one new feature acts as the ground truth label during the training process of the second ML model 220(2).

In a non-limiting implementation, the second convergence criteria are similar to the first convergence criteria. Moreover, once the second convergence criteria are met, the second ML model 220(2) can generate the predicted probability score that is highly accurate, thereby generating a highly accurate prediction for the value of the at least one new feature. In another non-limiting implementation, the one or more second model parameters are also similar to the one or more first model parameters and may be configured based on the type of model selected for the second ML model 220(2).

In one embodiment, the analysis module 230 is configured to predict a set of new feature values corresponding to the set of new features for the predefined training period. In a non-limiting example, the analysis module 230 predicts the set of new feature values using the second ML model 220(2). The predicted new feature value or a predicted feature is provided to the concatenation module 228.

In an embodiment, the concatenation module 228 may include suitable logic and/or interfaces for generating a second training feature set (i.e., the new training feature set) for each training data sample based, at least in part, on the corresponding predicted value and the corresponding training feature set. More specifically, the concatenation module 228 may generate the new training feature set by concatenating the set of predicted new feature values (i.e., the corresponding predicted value) with the first training feature set. It is to be noted that the concatenation step is performed using a predefined concatenation process. The predefined concatenation process may correspond to a process of placing elements of two or more strings adjacent to each other.

Further, the training module 226 may be configured to re-train the first ML model 220(2) to perform the predefined task based, at least in part, on the second training feature set. In one embodiment, for re-training the first ML model 220(2) to obtain a re-trained ML model (i.e., a re-trained first ML model), the training model 226 is configured to perform a third set of operations iteratively until third convergence criteria are met. The third set of operations may include: (i) initializing the first ML model 220(1) based, at least in part, the new training feature set, a corresponding ground truth label associated with each training data sample, and the one or more first model parameters; (ii) generating, by the first ML model 220(1), a new predicted probability score for each training data sample in the training dataset based, at least in part, on the new training feature set and the one or more first model parameters, the new predicted probability score indicating a likelihood of performing the predefined task; (iii) generating, by the first ML model 220(1), a new prediction for the predefined task based, at least in part, on the new predicted probability score and the task threshold, the new prediction including a new label associated with the predefined task; (iv) computing, by the first ML model 220(1), a loss for each training data sample in the training dataset based, at least in part, on the new prediction, the corresponding ground truth label, and a loss function; and (v) optimizing the one or more first model parameters based, at least in part, on the loss. As may be understood, the optimization step can be performed based, at least on a backpropagation of the loss.

In a non-limiting implementation, the third convergence criteria are similar to the second convergence criteria. Moreover, once the third convergence criteria are met, the re-trained ML model is obtained. Further, using the re-trained ML model, the new predicted probability score that is highly accurate can be generated. As a result, the re-trained ML model can be used to generate a highly accurate new prediction for the predefined task. Since the re-trained ML model is trained on the new training feature set which also includes the new features that have appeared during the testing period of the first ML model 220(1), the performance of the re-trained ML model may have to be better than that of the first ML model 220(1).

To that end, in order to measure the improvement in the performance of the first ML model 220(1), the analysis module 230 may be configured to compute a first performance metric associated with the first ML model 220(1) based, at least in part, on the testing feature set. The analysis module 230 may further be configured to compute a second performance metric associated with the re-trained ML model based, at least in part, on the testing feature set. Further, the analysis module 230 may be configured to compute an improvisation factor based, at least in part, on the first performance metric and the second performance metric. The improvisation factor may indicate an extent of a positive impact on the performance of the first ML model 220(1) due to the re-training process. It is to be noted that the several experiments have been conducted to check the improvisation factor. The results of such experiments are explained later in the present disclosure.

In some embodiments, the analysis module 230 can receive a prediction request related to the predefined task from a user (e.g., the payment processor). The analysis module 230 may generate a new prediction corresponding to the predefined task based, at least in part, on the testing feature set for each testing data sample. Herein, the testing feature set may include the at least one new feature. In one embodiment, the analysis module 230 generates the new prediction using the re-trained ML model. Further, in response to the prediction request, the analysis module 230 may transmit the new prediction to the user.

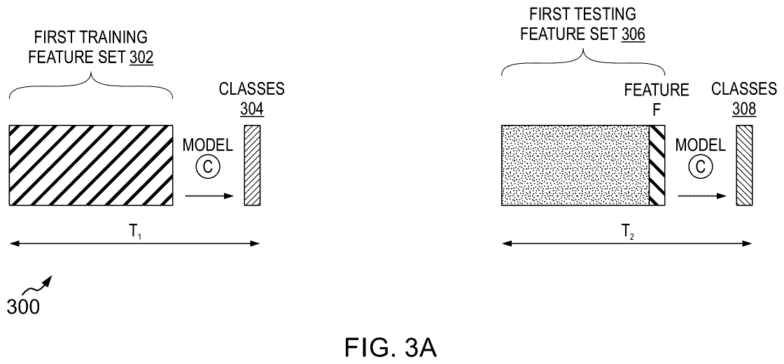

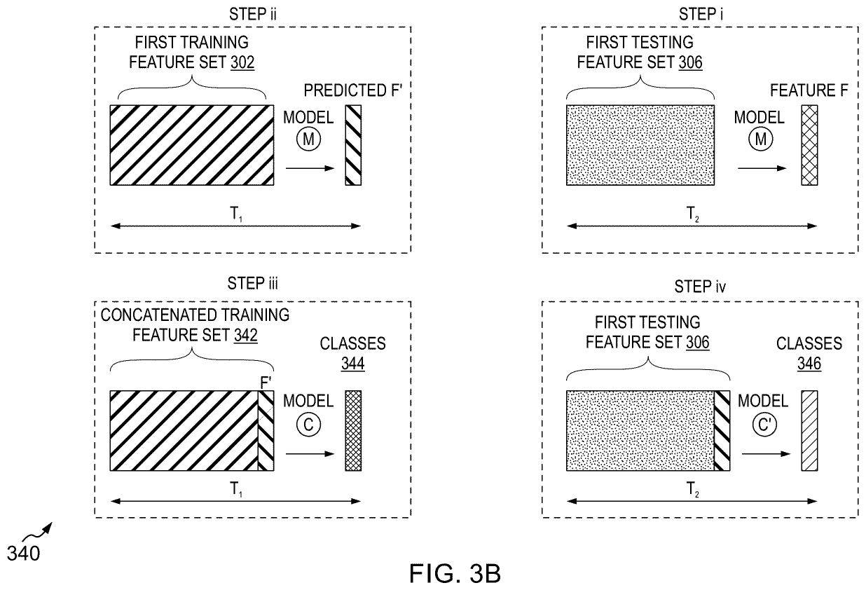

FIG. 3A illustrates a schematic representation 300 of an initial configuration of training and testing the ML model such as a model ‘C’, in accordance with an embodiment of the present disclosure. In an embodiment, the model ‘C’ is similar to the first ML model 220(1) of FIG. 2. Considering the example of the payment fraud detection, the initial configuration of the model such as the model ‘C’ may correspond to the model ‘C’ being trained to perform a predefined task such as a classification task. The classification task may be the payment fraud detection task. This operation may be performed by the server system 200. Further, for the server system 200 to be able to perform this operation, the server system 200 needs to have access to the features based on which the model ‘C’ can be trained. Thus, in an embodiment, the server system 200 is configured to access the plurality of features from the database 204. The features may include the first training feature set (e.g., the first training feature set 302) for the predefined training period (e.g., T₁) and the first testing feature set (e.g., the first testing feature set 306) for the predefined testing period (e.g., T₂). In one embodiment, the plurality of features may include a validation feature set as well for a predefined validation period. In a non-limiting example, the first training feature set 302 can include features related to historical fraud transactions and non-fraud transactions generated from the training dataset including the historical transaction data for the predefined training period ‘T₁’.

Further, the server system 200 may be configured to train the model ‘C’ to perform the predefined task based, at least in part, on the first training feature set 302 as shown in FIG. 3A. In a specific scenario, when the predefined task is a classification task, during the predefined training period, T₁, the model ‘C’ is configured to predict the class of a particular transaction based on the first training feature set 302. In other words, for a plurality of transactions, the model ‘C’ outputs classes such as classes 304 which correspond to classes assigned to all the payment transactions performed by the cardholders (e.g., the cardholders 104). In an embodiment, each class of the classes 304 may be associated with a label of either a fraudulent class or a non-fraudulent class.

Further, to test the trained model ‘C’, a first testing feature set 306 is fed to the trained model ‘C’. The first testing feature set 306 may be for a predefined testing period ‘T₂’. In a specific embodiment, the first testing feature set 306 may be influenced by an extra feature such as ‘F’. For instance, it may happen that the organization or the operator that built this model ‘C’ may start collecting some extra attributes (e.g., card type) for transactions during the deployment or testing period of the trained model ‘C’. However, since the model ‘C’ is unaware of this new feature ‘F’, as it was not included in the first training feature set 302, classification results such as classes 308 assigned to transactions performed by the cardholders 104 may not exactly match with the classes 304 generated at the time of training the model ‘C’. As a result, the performance of the model ‘C’ may be observed to be negatively affected. Thus, a method is proposed in the present disclosure that facilitates the consideration of the extra feature ‘F’ for the predefined training period T₁, which is explained further with reference to FIG. 3B.

Similarly, at the time of deployment of the model ‘C’, a real-time dataset that may be fed to the model ‘C’ might also be influenced by one or more new features. These new features have newly appeared during the deployment phase and were not used while training the model ‘C’. Thus, a similar problem that was faced at the time of testing the model ‘C’, might be faced at the time of deployment as well. The present disclosure explains only the scenario of the testing phase and not of the deployment phase for the sake of brevity.

FIG. 3B illustrates a schematic representation 340 of an approach of incorporating predicted features in the first training feature set 302 for re-training the ML model ‘C’, in accordance with an embodiment of the present disclosure. In one embodiment, the approach of incorporating the predicted features in the first training feature set 302 includes four steps, such as step i, step ii, step iii, and step iv. According to step i of the approach, the extra feature ‘F’, is treated as a label, and a surrogate model such as the model ‘M’, is trained on the testing data (e.g., the first testing feature set 306) to predict the extra feature ‘F’ that may appear during the predefined testing period T₂. In other words, the server system 200 is configured to train the model ‘M’ to predict a set of new features (e.g., the extra feature F) that have appeared during the predefined testing period T₂ based, at least in part, on the first testing feature set 306. It is to be noted that the set of new features may include at least one new feature that has appeared during the predefined testing period T₂ of the model ‘C’. In a non-limiting implementation, the model ‘M’ is similar to the second ML model 220(2) of FIG. 2.

This model ‘M’ can then be applied to the training data (e.g., the first training feature set 302) to predict a new feature ‘F’. This operation is performed by the server system 200. In other words, the server system 200 is configured to predict a set of new feature values (otherwise, also referred to as feature ‘F’) corresponding to the set of new features (e.g., the extra feature ‘F’) for the predefined training period T₁. In one embodiment, the server system 200 predicts the set of new feature values using the model ‘M’.

This newly generated feature column ‘F’ can now be augmented or concatenated with the previous training data i.e., the first training feature set 302 for obtaining a concatenated training feature set 342 as shown in FIG. 3B. Thus, in an embodiment, the server system 200 is configured to generate the second training feature set (e.g., the concatenated training feature set 342) based, at least in part, on concatenating the set of predicted new feature values ‘F’ with the first training feature set 302. In an embodiment, the server system 200 may generate the second training feature set by concatenating the set of predicted new feature values ‘F’ with the first training feature set 302 using the predefined concatenation process.

Further, another version of the classifier (e.g., another version of model ‘C’) can be trained with the same training labels (e.g., fraudulent class and non-fraudulent class). This operation is also performed by the server system 200. In other words, the server system 200 may be configured to re-train the first ML model (e.g., another version of model ‘C’ such as a model ‘C’) to perform the predefined task based, at least in part, on the second training feature set. Herein, the model ‘C’ is similar to a re-trained version of the first ML model 220(1) of FIG. 2. In a specific scenario of the predefined task being the classification task, during the training process, the classes predicted for the payment transactions performed by the cardholders 104 such as classes 344 may be new labels assigned to the payment transactions based on the second training feature set. Later, this re-trained model ‘C’ can then be tested for its operation using the same testing data i.e., the first testing feature set 306. Thus, the server system 200 may be configured to test the model ‘C’ for its operation. More specifically, the server system 200 predicts classes such as classes 346 for payment transactions for the predefined testing period T₂, based at least on the first testing feature set 306. In an embodiment, the server system 200 predicts the classes 346 using the model ‘C’. It is to be noted that the first testing feature set 306 has the extra feature ‘F’ which is obtained from the ground truth labels obtained while training the model ‘M’ to predict the extra feature ‘F’. This is how a new version of the model ‘C’ is obtained which corresponds to the model ‘C’. Since the model ‘C’ is now aware of the extra feature ‘F’ that may appear during the testing or deployment period, the classification results such as the classes 346 may partially or approximately match with the classes 344 generated at the time of training the model ‘C’ based at least on the second training feature set. Further, the performance of the model ‘C’ may be evaluated. Since the classes 346 and the classes 344 are expected to match, the approach explained with reference to FIG. 3B, facilitates improvement in the model performance. In order to validate the improvement in the model performance, several experiments have been conducted on different datasets which are explained with their respective results further in the present disclosure.

For instance, consider a classical pattern classification scenario, where a tabular data set X={X₁¹, X₁², X₁³, . . . . Xᵢ¹, . . . . Xₙ¹} is available for training the model ‘C’ from n data samples. Here, X₁¹, X₁², X₁³, . . . . Xᵢ¹, . . . . Xₙ¹ represent n number of data samples, while n is a non-zero natural number. Subsequently, for testing the model ‘C’ for the testing data considered is P={P₁¹, P₁², P₁³, . . . Pᵢ¹, . . . Pₘ¹} for m testing samples. Here, P₁¹, P₁², P₁³, . . . Pᵢ¹, . . . Pₘ¹ represent m number of data samples, while m is also a non-zero natural number. Suppose the set of features that are available for training and testing initially is given by F={F₁¹, F₁², F₁³, . . . Fᵢ¹, . . . Fₜ¹}. Utilizing the [symbol] training data, a model C_{θ}(c): [symbol] ^{t}→ [symbol] is trained by the server system 200, where t is the dimensionality or the number of features available during training, and θ(j) are the parameters of the model ‘C’.

Further, consider a scenario where during testing, an extra feature column Fₜ₊₁ is made available in addition to F, such that F∪Fₜ₊₁=F′. The server system 200 then trains a [symbol] surrogate model M_{θ}(m): [symbol] ^{t}→ [symbol] . More specifically, the server system 200 enables this surrogate model to learn to predict the extra variable Fₜ₊₁ from F using the data provided in the test set P. This model ‘M’ may be then used to infer from X to generate Fₜ₊₁ on the training dataset. Now, since the server system 200 is able to generate one extra feature column for the training data, the [symbol] server system 200 can train another model C_{θ}′(m): [symbol] ^{t+1}→ [symbol] on X and then use it for inferencing on the same testing data P.

In another instance, there are n features while training the surrogate model ‘M’, such as F₁, F₂, . . . Fₙ. Further, the feature being estimated is F′. Then, the surrogate model ‘M’ may be used to predict feature F′ in the training window based at least on a predefined condition. In an embodiment, the predefined condition may include a condition according to which the model ‘M’ is used only when there does not exist a linear relationship between the features F₁, F₂, . . . Fₙ, and the estimated feature F′. The predefined condition may also include a condition such that if there exists a linear relationship between the features F₁, F₂, . . . Fₙ and the estimated feature F′, then the estimated feature F′ may not be used for model re-training.

In some embodiments, the approach proposed in the present disclosure can be applicable to categorical features as well. In an example scenario, if the features utilized during the training phase had two categories of features, i.e., category ‘X’ and category ‘Y’, and during the testing phase, two new categories of features, i.e., category ‘V’ and category ‘W’ are introduced. Then, in such a scenario, the proposed approach can re-train the ML model to estimate or predict the category ‘V’ and category ‘W’ as well.

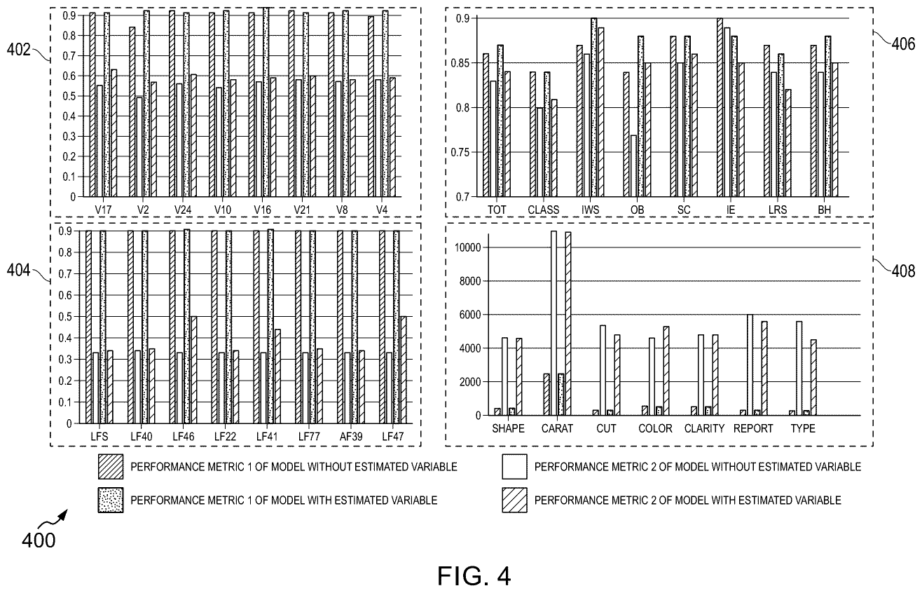

FIG. 4 illustrates a graphical representation 400 of experimental results obtained for a surrogate model such as the model ‘M’ for different input datasets, in accordance with an embodiment of the present disclosure. In the experiments conducted to support the proposed approach, the results are demonstrated on two different kinds of the input datasets in predefined setups. The predefined setups may correspond to a financial domain and in general tasks. In the financial domain, a credit card fraud dataset is considered to detect fraudulent credit card transactions. Further, in the general tasks setup, a bitcoin transaction dataset is considered to detect bitcoin transaction fraud. Both are tabular datasets, however, only a Principal Component Analysis (PCA) representation of the features is used. As used herein, the term ‘principal component analysis representation’ refers to a representation of features that transforms the features into new and uncorrelated variables. These uncorrelated variables are also referred to as principal components. It is to be noted that these components capture a maximum variance in the data, with successive components explaining less variance. Also, these transformed features are linear combinations of the original features. As a result, the dimensionality is reduced while retaining the most important information. Further, it is understood that for the purposes of experimentation, publicly available datasets have been used.

The proposed approach is further evaluated/tested on two general tabular datasets such as an airline satisfaction dataset where the task is to predict customer satisfaction, and a brilliant diamonds dataset where the task is to predict the price of a diamond.

Further, an example of the credit card dataset may correspond to a Kaggle® credit card fraud dataset. This dataset contains transactions made by credit card users (e.g., the cardholders 104). It may have approximately 284,807 transactions out of which approximately 492 may be fraudulent transactions. This dataset is highly imbalanced where fraudulent transactions account for about 0.172% of all the transactions. There may be about 28 numerical features obtained as an output of PCA transformation along with “amount” and “time”.

An example of the bitcoin transaction dataset may correspond to an Elliptic® bitcoin fraud dataset. This dataset maps Bitcoin transactions to real entities belonging to licit (such as exchanges, wallet providers, miners, licit services, etc.,) and illicit categories (such as scams, malware, terrorist organizations, ransomware, Ponzi schemes, etc.). This dataset is presented as a transaction graph, each node being a bitcoin transaction, and an edge representing the flow of bitcoins between the transactions. This dataset may include approximately 203,769 nodes/data samples, out of which about 4,545 (around 2%) are labeled as illicit, 42,019 (around 21%) samples are labeled as licit, and the rest are unlabeled.

Further, the airline satisfaction dataset may include results of an airline customer satisfaction survey. The total number of samples in this dataset may include approximately 103904 out of which about 43.3% of the customers may be satisfied with an airline service while the rest are either neutral or dissatisfied. It has about 24 features with about 5 categorical features and the rest being numeric.

Further, the brilliant diamonds dataset may include records for natural and lab-created diamonds. The total number of samples in this dataset may be approximately 119,307. The task here is to predict the price of a diamond based on various attributes like cut, color, clarity, etc. It has about 11 features with about 8 categorical features and the rest numerical features.

The results of the experiments disclosed in the present disclosure, for validation of the proposed approach, are also compared with relevant assumed baselines. Consider an experiment of training a surrogate model ‘M’. In this experiment, the effectiveness of the proposed approach may be shown by training the model ‘M’ (hereinafter, interchangeably also referred to as a surrogate model ‘M’) to estimate new variables (such as feature ‘F’) encountered during evaluation. In this setting, the testing dataset has new variables that were not seen during model training. The surrogate model ‘M’ is trained using the features available in the testing dataset (omitting the target variable i.e., the target classes) to estimate this new variable ‘F’. The surrogate model ‘M’ can then be used to estimate this new variable ‘F’ in the training dataset as well. This estimated variable can be used to re-train a model such as the model ‘C’ to predict the original target or class. The experimental results for this experiment are illustrated in FIG. 4. It is noted that the results shown in FIG. 4 are approximate in nature and may vary by a factor of ±5% due to various experimental conditions.

In the credit card dataset, as shown in FIG. 4 (see, 402), it may be observed that the area under the precision-recall curve (AUC-PR) of the model (e.g., the first ML model 220(1)) using the estimated variables increases compared to the model utilizing only the originally present features in the training dataset. It may be observed that the features “V17” and “V2” show a measurable performance lift upon estimation.

In the Elliptic® bitcoin dataset shown in FIG. 4 (see, 404), it may be observed that the features “local_feature_47 (LF47)”, “local_feature_46 (LF46)” and “local_feature 41 (LF41)” also show a measurable improvement upon estimation.

Similarly, the airline satisfaction dataset shown in FIG. 4 (see, 406), also shows a performance improvement for many variables upon estimation using the surrogate model ‘M’. Variables “online boarding (OB)” and “inflight Wi-Fi service (IWF)” show a measurable improvement. It may also be observed that some variables show poor performance on estimation. For example, the “inflight entertainment (IE)” and “leg room service (LRS)” variables show inferior performance compared to the model without using these estimated variables.

Further, for the brilliant diamonds dataset shown in FIG. 4 (see, 408), variables “type” and “cut” also show a measurable improvement in terms of root mean squared error (RMSE). The variable “color” shows poor performance on estimation. Moreover, for the first 3 plots 402, 404, and 406 performance metrics 1 and 3 are Area under the receiver operating curve (ROC) and performance metrics 2 and 4 are AUC-PR.

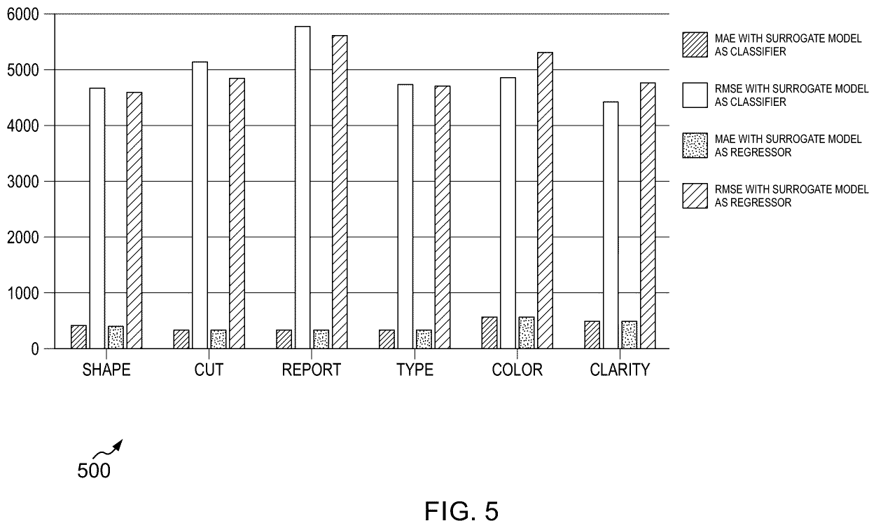

FIG. 5 illustrates a graphical representation 500 of experimental results for applying the proposed approach on a predefined dataset using classifier and regressor surrogate models, in accordance with an embodiment of the present disclosure. In the experiment conducted for this purpose, the predefined dataset may include the brilliant diamonds dataset described earlier.

This experiment is conducted to test the efficacy of using regression and classification tasks to build the surrogate model ‘M’. In the regression task, the surrogate model ‘M’ can estimate the new variable using continuous numerical values while the classifier surrogate model can estimate the new variable using a probability value bounded by the interval [0,1]. Thus, FIG. 5 illustrates experimental results indicating the change observed in performance upon using classifier and regressor surrogate models on the brilliant diamonds dataset. For this experiment, only categorical variables may be considered. It is noted that the results shown in FIG. 5 are approximate in nature and may vary by a factor of ±5% due to various experimental conditions.

In FIG. 5, different model types are used for variable estimation such as a classifier and regressor. It may be observed that there is no clear distinction in terms of model performance when using these different types of models.

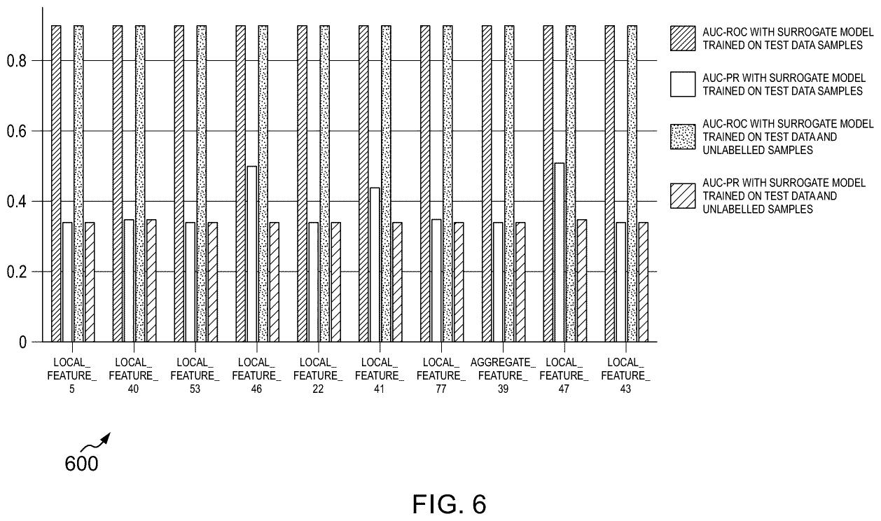

FIG. 6 illustrates a graphical representation 600 of experimental results for applying the proposed approach on another predefined dataset using a surrogate model, in accordance with an embodiment of the present disclosure. In the experiment conducted for this purpose, the another predefined dataset may include the Elliptic® bitcoin dataset.

This experiment utilizes an unlabeled dataset. In this experiment, an observation is made on the performance of the surrogate model when additional data is provided for training. In the Elliptic® bitcoin fraud dataset, about 77% of data is unlabeled, which cannot be used for direct modeling. The experiment was performed to compare the performance of the proposed approach when the surrogate model ‘M’ is trained using different data sources. In the first case, only the testing dataset is used for training the surrogate model ‘M’. In the second case, the testing dataset along with unlabeled data is used to train the surrogate model. Thus, it is to be noted that FIG. 6 shows the results of this experiment. It is noted that the results shown in FIG. 6 are approximate in nature and may vary by a factor of ±5% due to various experimental conditions.

In FIG. 6, unlabeled data is used to train the surrogate model ‘M’ for variable estimation. It may be observed that the surrogate model ‘M’ using only labeled data performs measurably better than the model using both labeled and unlabeled data for variable estimation.

The above-mentioned experiments follow an experiment protocol. According to the experiment protocol, the input dataset may be divided into two parts, such as a training dataset and a testing dataset. The testing dataset may include variables that were not seen during training. A surrogate model ‘M’ is trained on the testing dataset to predict the variables not seen in the training dataset. This surrogate model ‘M’ is then used to estimate these variables that were not present in the training dataset. A model is trained to predict the target using two different sets of features. A first model uses only those features that are originally present in the training dataset. A second model uses the estimated features along with the originally present features.

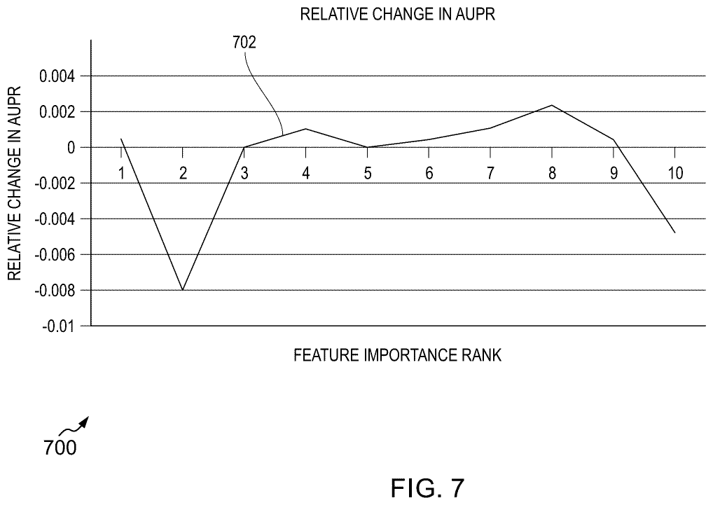

FIG. 7 illustrates a graphical representation 700 of experimental results for relative change in a predefined performance metric after feature estimation for yet another defined dataset having features with different feature importance ranks, in accordance with an embodiment of the present disclosure. In this experiment, the predefined dataset considered may include account and transaction level data of an issuer (e.g., the issuer 108(1)). In a non-limiting example, the account-level data may include age, credit limit, days past due, balance past due, etc. Further, the transaction-level data may include MCC, transaction amount, PAN entry mode, etc. Moreover, the model may be trained to perform a credit risk project with the predefined dataset in a certain geographical area.

Further, the features extracted from this input dataset may include about 100 features. Herein, the top 10 features may be selected from the 100 features for training the model to perform a task such as generating a delinquency score for payment transactions in the input dataset. Examples of the features may include a transaction count for the past 200/120/90/30/7 days, minimum balance past due in the last 6 months, a sum of transaction amount for card-present (CP) transactions in the past 7 days, etc.

From FIG. 7, it may be observed that the relative change in AUC-PR with respect to the feature importance rank associated with each feature is measurably improved for some features. Referring to a curve 702 in FIG. 7, it may be observed that the features with feature importance rank 1, rank 4, rank 7, rank 8, and rank 9 have the AUC-PR that is improved. However, the rest of the features observe a fall in the AUC-PR of the model.

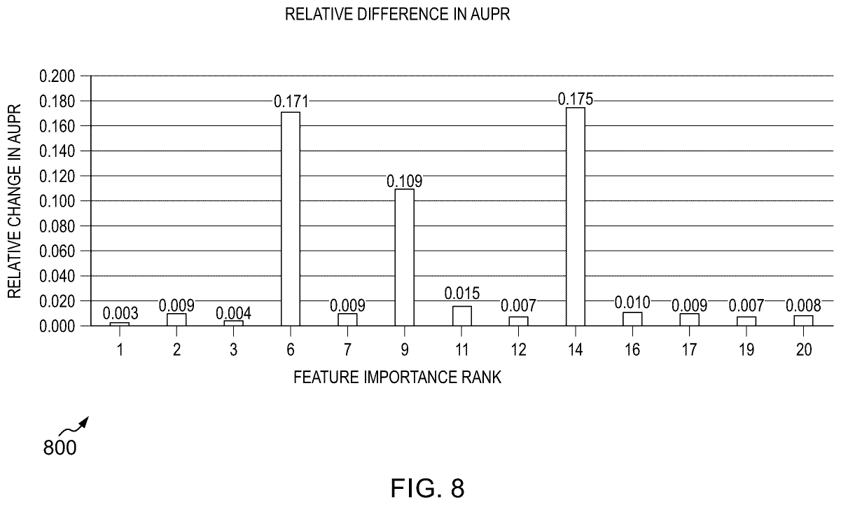

FIG. 8 illustrates a graphical representation 800 of experimental results for the relative change in a predefined performance metric after feature estimation for yet another defined dataset having features with different feature importance ranks, in accordance with an embodiment of the present disclosure. In this experiment, the predefined dataset may include the Elliptic® bitcoin dataset. Herein, the Elliptic® bitcoin dataset may correspond to transactional data for bitcoin transactions.

Moreover, the model may be trained to perform a classification task such as classifying licit and illicit transactions. This dataset may be graphical, and hence, the overall number of nodes may correspond to about 203, 769, of which about 2% are licit transactions and about 21% are illicit transactions. The training strategy used for training a model based on the Elliptic® bitcoin dataset may include ignoring unknown classes. In the experiment, the top 20 features may be provided as input for training the model.

From FIG. 8, it may be observed that the relative change in area under a precision-recall (PR) curve (AUPR) with respect to the feature importance rank associated with each feature is improved for some features. The features with feature importance rank 6, rank 9, and rank 14 may observe a large gain. However, the rest of the features observe a fall in the AUPR of the model. It is noted that the results shown in FIG. 7 are approximate in nature and may vary by a factor of ±5% due to various experimental conditions.

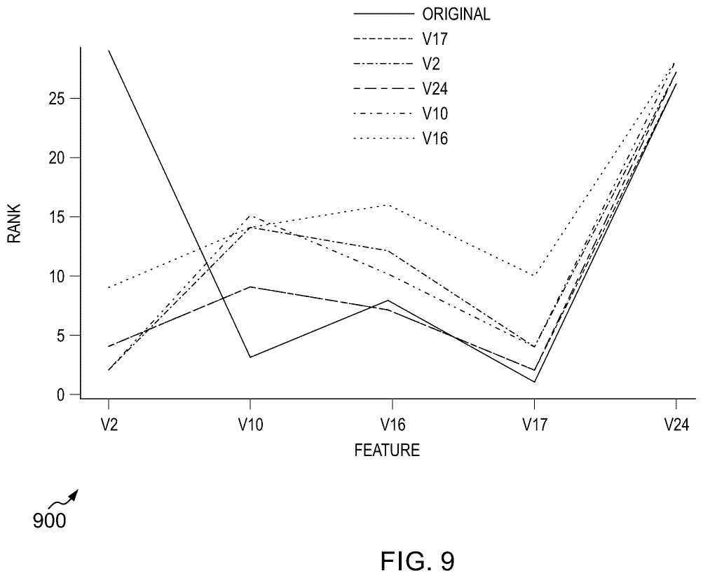

FIG. 9 illustrates a graphical representation 900 of experimental results for relative change in feature importance rank after feature estimation for yet another defined dataset, in accordance with an embodiment of the present disclosure. In this analysis, initially, the feature importance of different variables in the input dataset is checked where all variables (without estimation) are used for model training. After this, each of the variables is estimated using the surrogate model ‘M’. The estimated variable is used instead of the original variable, and the change in the feature importance rank of the estimated variable is observed. In FIG. 9, a relative change in feature importance rank is observed for the credit card dataset. Some variables like “V16” show a measurable change in the feature importance rank after variable estimation using the surrogate model ‘M’ is performed. It is noted that the results shown in FIG. 9 are approximate in nature and may vary by a factor of ±5% due to various experimental conditions.

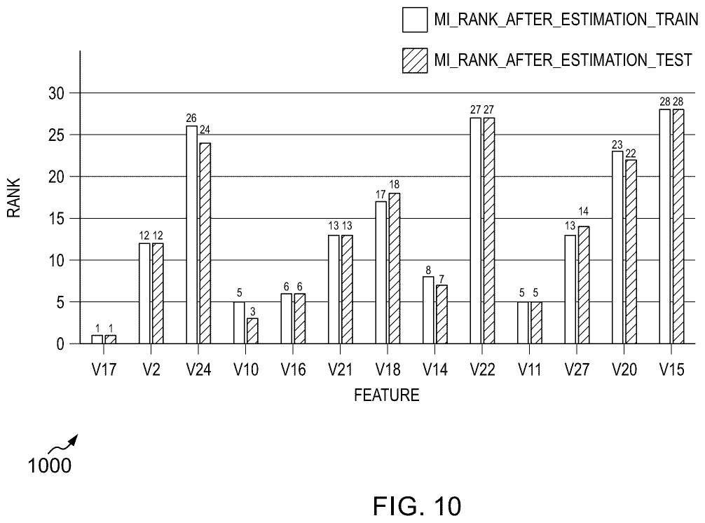

FIG. 10 illustrates a graphical representation 1000 of experimental results for mutual information rank of estimated variables with the target, in accordance with an embodiment of the present disclosure. Further, experiments have been conducted to explore the relationship between the estimated variables and the original variable (i.e., the target). The mutual information may be used as a criterion to evaluate how much information from the original variable has been captured by the estimated variable.

Further, results obtained from such experiments may be analyzed. This analysis further helps to understand if the relationship exhibited by the estimated and target variable holds in the training dataset as well as the testing dataset. In FIG. 10, the mutual information rank is observed for a variable with the target for the training dataset and the testing dataset. It may be observed that most of the variables show consistent mutual information rank for both the input datasets. It is noted that the results shown in FIG. 10 are approximate in nature and may vary by a factor of ±5% due to various experimental conditions

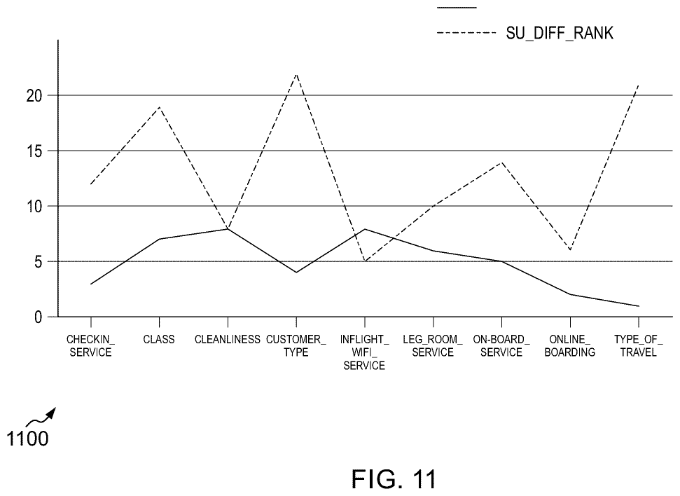

FIG. 11 illustrates a graphical representation 1100 of experimental results for comparison of gain observed on estimating feature v/s symmetrical uncertainty (SU) of feature with a target for a predefined dataset, in accordance with an embodiment of the present disclosure.

In this experiment, a condition is considered. The condition states that a feature is good if it is relevant with respect to the target and is not redundant with respect to the other relevant features. Further, if a feature is relevant enough to the target, then even if it is correlated with other features it would be regarded as a good feature for the prediction task.

Furthermore, it is noted that information gain is biased towards features with more values. Values should be normalized to ensure that they are comparable and have similar effects. Hence, symmetrical uncertainty (SU) is used. In a non-limiting implementation, an equation used for the computation of SU may correspond to the following:

$$SU ( X , Y ) = 2 \frac{IG ( X \vert Y )}{H ( X ) + H ( Y )} \qquad Eqn . ( 1 )$$

Herein, ‘IG’ stands for information gain. Information gain is a commonly used criterion to understand the extent of information that a variable provides for a given task. For example, IG is used to decide which variable to split while building a decision tree. Further, ‘H’ represents entropy, H(X) represents the entropy of ‘X’, and H(Y) represents the entropy of ‘Y’. Further, in a non-limiting example, a formula for calculating entropy is as follows:

$$H = - sum ( p * {log}_{2} ( p ) ) \qquad Eqn . ( 2 )$$

Herein, ‘p’ refers to the probability of each possible outcome.

The experiment is performed where a performance gain observed on estimating a feature (denoted by “gain_rank” in FIG. 11) is checked. Further, initially, SU of the estimated feature with the target variable is calculated using Eqn. (1). Later, the SU of the estimated feature with other features is calculated. The absolute difference between these two is ranked (denoted by “su_diff_rank” in FIG. 11).

In FIG. 11, the performance gain observed when a feature is estimated is compared with the maximum difference of SU of the feature with other features and the SU of the feature with the target. It may be verified whether the features showing measurable performance gain on estimation have higher SU differences as well. For the airline satisfaction dataset, it may be observed that this relationship holds for some of the variables like “Class” and “onboard service”, while this relationship does not hold for some of the variables like “Customer type” and “Type of travel”. It is noted that the results shown in FIG. 11 are approximate in nature and may vary by a factor of ±5% due to various experimental conditions.

Thus, it may be concluded from the various experiments that real-world AI/ML models are trained on features acquired in a fixed time interval. These AI/ML models are then used for testing/evaluation in the real world in a different time period that was used for training. For instance, if after a certain period of time new features/variables are available for inferencing in addition to the existing features that were utilized for training the model, the approach described by the various embodiments of the present disclosure may be utilized to allow the incorporation of these features in the trained model so that the model can be re-trained. Once re-trained, this new version of the model will yield better performance on the downstream task on the test set when compared to its previous version.

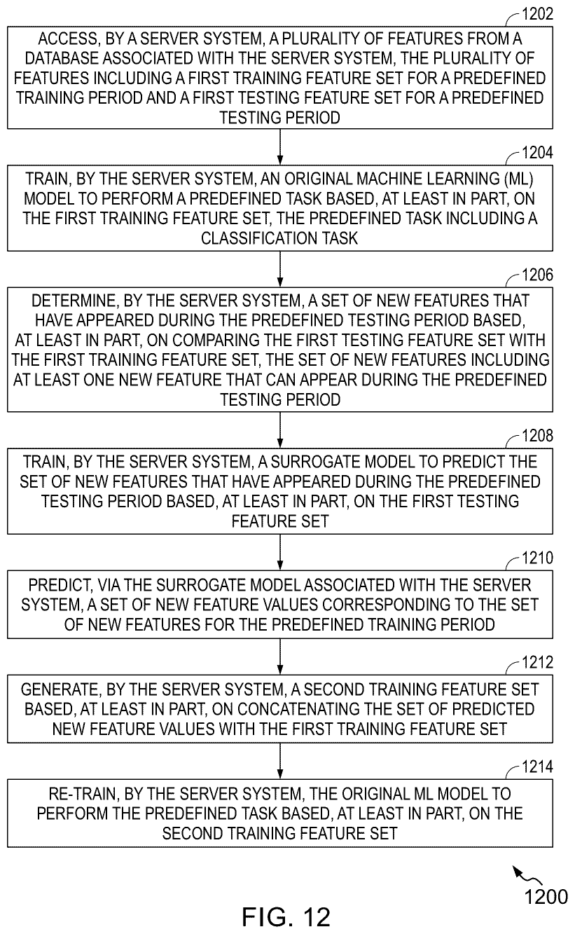

FIG. 12 illustrates a process flow diagram depicting a method 1200 for determining unknown features that appear during the testing or deployment phase of an ML model and re-training the ML model by considering the determined features, in accordance with an embodiment of the present disclosure. The method 1200 depicted in the flow diagram may be executed by, for example, the server system 200. The sequence of operations of the method 1200 may not be necessarily executed in the same order as they are presented. Further, one or more operations may be grouped and performed in the form of a single step, or one operation may have several sub-steps that may be performed in parallel or in a sequential manner. Operations of the method 1200, and combinations of operations in the method 1200 may be implemented by, for example, hardware, firmware, a processor, circuitry, and/or a different device associated with the execution of software that includes one or more computer program instructions. The plurality of operations is depicted in the process flow of the method 1200. The process flow starts at operation 1202.

At 1202, the method 1200 includes accessing, by a server system (e.g., the server system 200), a plurality of features from a database (e.g., the database 204) associated with the server system 200. The plurality of features may include a first training feature set (e.g., the first training feature set 302) for a predefined training period (e.g., the predefined training period T₁) and a first testing feature set (e.g., the first testing feature set 306) for a predefined testing period (e.g., the predefined testing period T₂).

At 1204, the method 1200 includes training, by the server system 200, an original ML model (e.g., the first ML model 220(1)) to perform a predefined task based, at least in part, on the first training feature set 302. In an embodiment, the predefined task may be a classification task.

At 1206, the method 1200 includes determining, by the server system 200, a set of new features (e.g., the extra feature F) that have appeared during the predefined testing period T₂ based, at least in part, on comparing the first testing feature set 306 with the first training feature set 302. The set of new features includes at least one new feature (e.g., the extra feature F) that can appear during the predefined testing period T₂.

At 1208, the method 1200 includes training, by the server system 200, a surrogate model ‘M’ (e.g., second ML model 220(2)) to predict the set of new features that have appeared during the predefined testing period T₂ based, at least in part, on the first testing feature set 306.

At 1210, the method 1200 includes predicting, via the surrogate model associated with the server system 200, a set of new feature values (e.g., feature F′) corresponding to the set of new features (e.g., the extra feature F′) for the predefined training period T₁.

At 1212, the method 1200 includes generating, by the server system 200, a second training feature set (e.g., the concatenated training feature set 342) based, at least in part, on concatenating the set of predicted new feature values F′ with the first training feature set 302.

At 1214, the method 1200 includes re-training, by the server system 200, the original ML model ‘C’ to perform the predefined task based, at least in part, on the second training feature set.

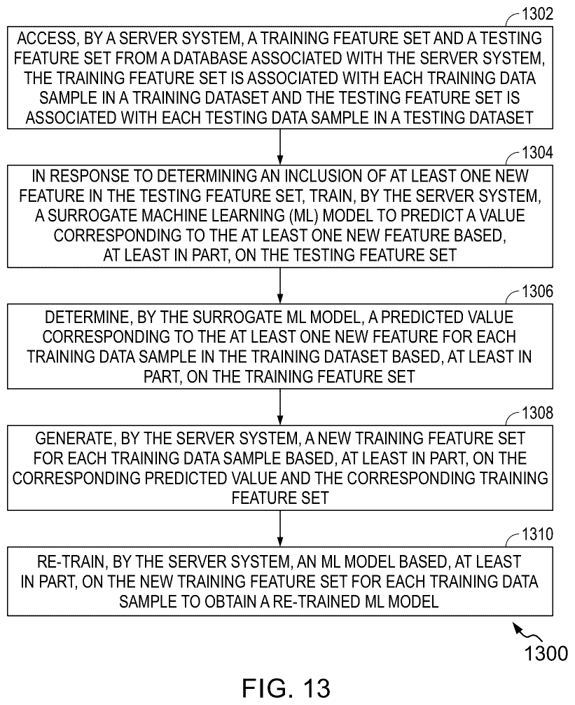

FIG. 13 illustrates a flow diagram depicting a method 1300 for re-training an ML model using predicted features from a training dataset, in accordance with an embodiment of the present disclosure. The method 1300 depicted in the flow diagram may be executed by, for example, the server system 200. The sequence of operations of the method 1300 may not be necessarily executed in the same order as they are presented. Further, one or more operations may be grouped and performed in the form of a single step, or one operation may have several sub-steps that may be performed in parallel or in a sequential manner. Operations of the method 1300, and combinations of operations in the method 1300 may be implemented by, for example, hardware, firmware, a processor, circuitry, and/or a different device associated with the execution of software that includes one or more computer program instructions. The plurality of operations is depicted in the process flow of the method 1300. The process flow starts at operation 1302.

At operation 1302, the method 1300 includes accessing, by a server system (e.g., the server system 200), a training feature set (e.g., the first training feature set 302) and a testing feature set (e.g., the first testing feature set 306) from a database (e.g., the database 204) associated with the server system 200. The training feature set is associated with each training data sample in a training dataset and the testing feature set is associated with each testing data sample in a testing dataset.

At operation 1304, in response to determining an inclusion of at least one new feature (e.g., the extra feature F) in the testing feature set, the method 1300 includes training, by the server system 200, a surrogate ML model ‘M’ (e.g., second ML model 220(2)) to predict a value corresponding to the at least one new feature based, at least in part, on the testing feature set.

At operation 1306, the method 1300 includes determining, by the surrogate ML model, a predicted value (e.g., feature F′) corresponding to the at least one new feature for each training data sample in the training dataset based, at least in part, on the training feature set.

At operation 1308, the method 1300 includes generating, by the server system 200, a new training feature set (e.g., the concatenated training feature set 342) for each training data sample based, at least in part, on the corresponding predicted value and the corresponding training feature set.

At operation 1310, the method 1300 includes re-training, by the server system 200, an ML model (e.g., the first ML model 220(1)) based, at least in part, on the new training feature set for each training data sample to obtain a re-trained ML model.

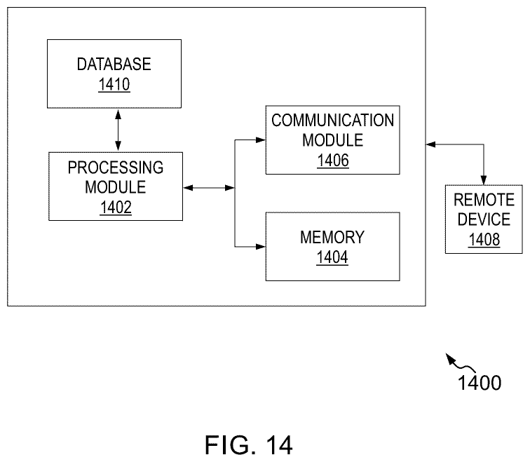

FIG. 14 illustrates a simplified block diagram of a payment server 1400, in accordance with an embodiment of the present disclosure. The payment server 1400 is an example of the payment server 114 of FIG. 1. The payment server 1400 and the server system 200 may use the payment network 112 as a payment interchange network.

The payment server 1400 includes a processing module 1402 configured to extract programming instructions from a memory 1404 to provide various features of the present disclosure. The components of the payment server 1400 provided herein may not be exhaustive, and the payment server 1400 may include more or fewer components than that depicted in FIG. 14. Further, two or more components may be embodied in one single component, and/or one component may be configured using multiple sub-components to achieve the desired functionalities. Some components of the payment server 1400 may be configured using hardware elements, software elements, firmware elements, and/or a combination thereof.

Via a communication module 1406, the processing module 1402 receives a request from a remote device 1408, such as the issuer servers 108, the acquirer servers 110, or the server system 102. The request may be a request for conducting the payment transaction. The communication may be achieved through API calls, without loss of generality. The payment server 1400 includes a database 1410. The database 1410 also includes transaction processing data such as issuer ID, country code, acquirer ID, and merchant ID (MID), among others.

When the payment server 1400 receives a payment transaction request from the acquirer servers 110 or a payment terminal (e.g., IoT device), the payment server 1400 may route the payment transaction request to the issuer servers 108. The database 1410 stores transaction IDs for identifying transaction details such as transaction amount, IoT device details, acquirer account information, transaction records, merchant account information, and the like.

In one example embodiment, the acquirer servers 110 is configured to send an authorization request message to the payment server 1400. The authorization request message includes, but is not limited to, the payment transaction request.

The processing module 1402 further sends the payment transaction request to the issuer servers 108 for facilitating the payment transactions from the remote device 1408. The processing module 1402 is further configured to notify the remote device 1408 of the transaction status in the form of an authorization response message via the communication module 1406. The authorization response message includes, but is not limited to, a payment transaction response received from the issuer servers 108. Alternatively, in one embodiment, the processing module 1402 is configured to send an authorization response message for declining the payment transaction request, via the communication module 1406, to the acquirer servers 110. In one embodiment, the processing module 1402 executes similar operations performed by the server system 200. However, for the sake of brevity, these operations are not explained herein.

The disclosed method with reference to FIG. 12 and FIG. 13, or one or more operations of the server system 200 may be implemented using software including computer-executable instructions stored on one or more computer-readable media (e.g., non-transitory computer-readable media, such as one or more optical media discs, volatile memory components (e.g., Dynamic Random Access Memory (DRAM) or Statis Random Access Memory (SRAM)), or nonvolatile memory or storage components (e.g., hard drives or solid-state nonvolatile memory components such as Flash memory components), and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication mode. Such a suitable communication mode includes, for example, the Internet, the World Wide Web, an intranet, software applications, cable (including fiber optic cable), magnetic communications, electromagnetic communications (including RF, microwave, and infrared (IR) communications), electronic communications, or other such communication modes.

Although the disclosure has been described with reference to specific exemplary embodiments, it is noted that various modifications and changes may be made to these embodiments without departing from the broad scope of the disclosure. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application-Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g., magneto-optical disks), Compact Disc Read-Only Memory (CD-ROM), Compact Disc Recordable CD-R, Compact Disc Rewritable CD-R/W), Digital Versatile Disc (DVD), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different from those which are disclosed. Therefore, although the disclosure has been described based on these exemplary embodiments, it is noted that certain modifications, variations, and alternative constructions may be apparent and well within the scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a server system, a training feature set and a testing feature set from a database associated with the server system, the training feature set associated with each training data sample in a training dataset and the testing feature set associated with each testing data sample in a testing dataset;
in response to determining an inclusion of at least one new feature in the testing feature set, training, by the server system, a surrogate Machine Learning (ML) model to predict a value corresponding to the at least one new feature based, at least in part, on the testing feature set;
determining, by the surrogate ML model, a predicted value corresponding to the at least one new feature for each training data sample in the training dataset based, at least in part, on the training feature set;
generating, by the server system, a new training feature set for each training data sample based, at least in part, on the corresponding predicted value and the corresponding training feature set; and
re-training, by the server system, an ML model based, at least in part, on the new training feature set for each training data sample to obtain a re-trained ML model.

2. The computer-implemented method as claimed in claim 1, further comprising:
training, by the server system, the ML model to perform a predefined task based, at least in part, on the training feature set and a corresponding ground truth label associated with each training data sample.

3. The computer-implemented method as claimed in claim 2, wherein training the ML model comprises performing iteratively until first convergence criteria are met, a first set of operations comprising:
initializing the ML model based, at least in part, on the training feature set and one or more first model parameters;
generating, by the ML model, a predicted probability score for each training data sample in the training dataset based, at least in part, on the training feature set and the one or more first model parameters, the predicted probability score indicating a likelihood of performing the predefined task;
generating, by the ML model, a prediction for the predefined task based, at least in part, on the predicted probability score and a task threshold, the prediction comprising a label associated with the predefined task;
computing, by the ML model, a loss for each training data sample in the training dataset based, at least in part, on the prediction, the corresponding ground truth label, and a loss function; and
optimizing the one or more first model parameters based, at least in part, on the loss.

4. The computer-implemented method as claimed in claim 1, further comprising:
accessing, by the server system, an input dataset from the database, the input dataset comprising a plurality of data samples associated with a plurality of users, and split into the training dataset recorded for a training period of the ML model and the testing dataset recorded for a testing period of the ML model;
generating, by the server system, a plurality of features for each data sample of the plurality of data samples based, at least in part, on the input dataset, the plurality of features comprising the training feature set generated for the training period and the testing feature set generated for the testing period of the ML model; and
storing, by the server system, the plurality of features for each data sample in the database.

5. The computer-implemented method as claimed in claim 1, wherein training the surrogate ML model comprises performing iteratively until second convergence criteria are met, a second set of operations comprising:
initializing the surrogate ML model based, at least in part, on the testing feature set and one or more second model parameters;
generating, by the surrogate ML model, a predicted probability score for each testing data sample in the testing dataset based, at least in part, on the testing feature set and the one or more second model parameters, the predicted probability score indicating a likelihood of predicting the value for the at least one new feature;
generating, by the surrogate ML model, a prediction for the value corresponding to the at least one new feature based, at least in part, on the predicted probability score and a threshold, the prediction comprising the value for the at least one new feature;
computing, by the surrogate ML model, a loss for each testing data sample in the testing dataset based, at least in part, on the prediction, the identified at least one new feature, and a loss function; and
optimizing the one or more second model parameters based, at least in part, on the loss.

6. The computer-implemented method as claimed in claim 1, wherein re-training the ML model comprises performing iteratively until third convergence criteria are met, a third set of operations comprising:
initializing the ML model based, at least in part, on the new training feature set, a corresponding ground truth label associated with each training data sample, and one or more first model parameters;
generating, by the ML model, a new predicted probability score for each training data sample in the training dataset based, at least in part, on the new training feature set and the one or more first model parameters, the new predicted probability score indicating a likelihood of performing the predefined task;
generating, by the ML model, a new prediction for the predefined task based, at least in part, on the new predicted probability score and a task threshold, the new prediction comprising a new label associated with the predefined task;
computing, by the ML model, a loss for each training data sample in the training dataset based, at least in part, on the new prediction, the corresponding ground truth label, and a loss function; and
optimizing the one or more first model parameters based, at least in part, on the loss.

7. The computer-implemented method as claimed in claim 1, further comprising:
receiving, by the server system, a prediction request related to a predefined task from a user;
generating, by the re-trained ML model associated with the server system, a new prediction corresponding to the predefined task based, at least in part, on the testing feature set for each testing data sample, the testing feature set comprising the at least one new feature; and
transmitting, by the server system, the new prediction to the user.

8. The computer-implemented method as claimed in claim 1, further comprising:
computing, by the server system, a first performance metric associated with the ML model based, at least in part, on the testing feature set;
computing, by the server system, a second performance metric associated with the re-trained ML model based, at least in part, on the testing feature set; and
computing, by the server system, an improvisation factor based, at least in part, on the first performance metric and the second performance metric, the improvisation factor indicating an extent of a positive impact on performance of the ML model due to the re-training process.

9. The computer-implemented method as claimed in claim 1, further comprising:
identifying, by the server system, a relationship between the at least one new feature and the testing feature set based, at least in part, on the testing feature set; and
in response to identifying that the relationship corresponds to a non-linear relationship, training, by the server system, the surrogate ML model to predict the value corresponding to the at least one new feature.

10. The computer-implemented method as claimed in claim 9, further comprising:
in response to identifying that the relationship corresponds to a linear relationship, discarding, by the server system, the at least one new feature for training the surrogate ML model.

11. A server system, comprising:
a communication interface;
a memory comprising executable instructions; and
a processor communicably coupled to the communication interface and the memory, the processor configured to cause the server system to at least:
access a training feature set and a testing feature set from a database associated with the server system, the training feature set is associated with each training data sample in a training dataset and the testing feature set is associated with each testing data sample in a testing dataset;
in response to determining an inclusion of at least one new feature in the testing feature set, train a surrogate Machine Learning (ML) model to predict a value corresponding to the at least one new feature based, at least in part, on the testing feature set;
determine, by the surrogate ML model, a predicted value corresponding to the at least one new feature for each training data sample in the training dataset based, at least in part, on the training feature set;
generate a new training feature set for each training data sample based, at least in part, on the corresponding predicted value and the corresponding training feature set; and
re-train an ML model based, at least in part, on the new training feature set for each training data sample to obtain a re-trained ML model.

12. The server system as claimed in claim 11, wherein the server system is further caused, at least in part, to train the ML model to perform a predefined task based, at least in part, on the training feature set and a corresponding ground truth label associated with each training data sample.

13. The server system as claimed in claim 12, wherein to train the ML model, the server system is further caused, at least in part, to perform iteratively until first convergence criteria are met, a first set of operations comprising:
initializing the ML model based, at least in part, on the training feature set and one or more first model parameters;
generating, by the ML model, a predicted probability score for each training data sample in the training dataset based, at least in part, on the training feature set and the one or more first model parameters, the predicted probability score indicating a likelihood of performing the predefined task;
generating, by the ML model, a prediction for the predefined task based, at least in part, on the predicted probability score and a task threshold, the prediction comprising a label associated with the predefined task;
computing, by the ML model, a loss for each training data sample in the training dataset based, at least in part, on the prediction, the corresponding ground truth label, and a loss function; and
optimizing the one or more first model parameters based, at least in part, on the loss.

14. The server system as claimed in claim 11, wherein the server system is further caused, at least in part, to:
access the input dataset from the database, the input dataset comprising a plurality of data samples associated with a plurality of users, and split into the training dataset recorded for a training period of the ML model and the testing dataset recorded for a testing period of the ML model;
generate a plurality of features for each data sample of the plurality of data samples based, at least in part, on the input dataset, the plurality of features comprising the training feature set generated for the training period and the testing feature set generated for the testing period of the ML model; and
store the plurality of features for each data sample in the database.

15. The server system as claimed in claim 11, wherein to train the surrogate ML model, the server system is further caused, at least in part, to perform iteratively until second convergence criteria are met, a second set of operations comprising:
initializing the surrogate ML model based, at least in part, on the testing feature set and one or more second model parameters;
generating, by the surrogate ML model, a predicted probability score for each testing data sample in the testing dataset based, at least in part, on the testing feature set and the one or more second model parameters, the predicted probability score indicating a likelihood of predicting the value for the at least one new feature;
generating, by the surrogate ML model, a prediction for the value corresponding to the at least one new feature based, at least in part, on the predicted probability score and a threshold, the prediction comprising the value for the at least one new feature;
computing, by the surrogate ML model, a loss for each testing data sample in the testing dataset based, at least in part, on the prediction, the identified at least one new feature, and a loss function; and
optimizing the one or more second model parameters based, at least in part, on the loss.

16. The server system as claimed in claim 11, wherein to re-train the ML model, the server system is further caused, at least in part, to perform iteratively until third convergence criteria are met, a third set of operations comprising:
initializing the ML model based, at least in part, on the new training feature set, a corresponding ground truth label associated with each training data sample and one or more first model parameters;
generating, by the ML model, a new predicted probability score for each training data sample in the training dataset based, at least in part, on the new training feature set and the one or more first model parameters, the new predicted probability score indicating a likelihood of performing the predefined task;
generating, by the ML model, a new prediction for the predefined task based, at least in part, on the predicted probability score and a task threshold, the new prediction comprising a new label associated with the predefined task;
computing, by the ML model, a loss for each training data sample in the training dataset based, at least in part, on the new prediction, the corresponding ground truth label, and a loss function; and
optimizing the one or more first model parameters based, at least in part, on the loss.

17. The server system as claimed in claim 11, wherein the server system is further caused, at least in part, to:
receive a prediction request related to a predefined task from a user;
generate, by a re-trained ML model associated with the server system, a new prediction corresponding to the predefined task based, at least in part, on the testing feature set for each testing data sample, the testing feature set comprising the at least one new feature; and
in response to the prediction request, transmit the new prediction to the user.

18. The server system as claimed in claim 11, wherein the server system is further caused, at least in part, to:
compute a first performance metric associated with the ML model based, at least in part, on the testing feature set;
compute a second performance metric associated with the re-trained ML model based, at least in part, on the testing feature set; and
compute an improvisation factor based, at least in part, on the first performance metric and the second performance metric, the improvisation factor indicating an extent of a positive impact on performance of the ML model due to the re-training process.

19. The server system as claimed in claim 11, wherein the server system is further caused, at least in part, to:
identify a relationship between the at least one new feature and the testing feature set based, at least in part, on the testing feature set;
in response to identifying that the relationship corresponds to a non-linear relationship, train the surrogate ML model to predict the value corresponding to the at least one new feature; and
in response to identifying that the relationship corresponds to a linear relationship, discard the at least one new feature for training the surrogate ML model.

20. A non-transitory computer-readable storage medium comprising computer-executable instructions that, when executed by at least a processor of a server system, cause the server system to perform a method comprising:
accessing a training feature set and a testing feature set from a database associated with the server system, the training feature set is associated with each training data sample in a training dataset and the testing feature set is associated with each testing data sample in a testing dataset;
in response to determining an inclusion of at least one new feature in the testing feature set, training a surrogate Machine Learning (ML) model to predict a value corresponding to the at least one new feature based, at least in part, on the testing feature set;
determining, by the surrogate ML model, a predicted value corresponding to the at least one new feature for each training data sample in the training dataset based, at least in part, on the training feature set;
generating a new training feature set for each training data sample based, at least in part, on the corresponding predicted value and the corresponding training feature set; and
re-training an ML model based, at least in part, on the new training feature set for each training data sample.
